(19) United States
(12) Patent Application Publication
(10) Pub. No.: US 2023/0226719 A1
(43) Pub. Date: Jul. 20, 2023

(54) MIXER APU IMPROVEMENTS

(71) Applicant: Oshkosh Corporation, Oshkosh, WI (US)

(72) Inventors: Bryan Datema, Rochester, MN (US); Clint Glunz, Rochester, MN (US); Robert Varao, Oshkosh, WI (US); Yanming Hou, Oshkosh, WI (US); Zhenyi Wei, Oshkosh, WI (US); Xiang Gong, Oshkosh, WI (US); Jarud Hoefker, Dodge Center, MN (US); Jacob Holst, Oshkosh, WI (US); Brian Scott, Oshkosh, WI (US); Chris Pugh, Oshkosh, WI (US); Ted Tesmer, Oshkosh, WI (US)

(73) Assignee: Oshkosh Corporation, Oshkosh, WI (US)

(21) Appl. No.: 18/095,319

(22) Filed: Jan. 10, 2023

Related U.S. Application Data
(60) Provisional application No. 63/299,456, filed on Jan. 14, 2022.
(60) Provisional application No. 63/435,401, filed on Dec. 27, 2022.
(60) Provisional application No. 63/436,513, filed on Dec. 31, 2022.
(60) Provisional application No. 63/437,263, filed on Jan. 5, 2023.

(51) Int. Cl. B28C 5/42; H01M 10/42; H01M 10/48; H02J 7/00; B60P 3/16

(52) U.S. Cl. CPC B28C 5/422; B28C 5/4213; B28C 5/4268; H01M 10/425; H01M 10/488; H02J 7/0047; B60P 3/16; H01M 2220/20

(57) ABSTRACT

A concrete mixer vehicle includes a mixer drum assembly, an energy storage device, an internal combustion engine, an auxiliary power unit, and an energy management controller. The internal combustion engine is configured to supply power to the mixer drum assembly. The auxiliary power unit is configured to supply power from the energy storage device to the mixer drum assembly. The energy management controller is configured to engage the APU and disengage the ICE based on a state of charge of the energy storage device.

### CROSS-REFERENCE TO RELATED APPLICATIONS

This application claims priority to U.S. Provisional Patent Application No. 63/299,456, filed Jan. 14, 2022; U.S. Provisional Patent Application No. 63/435,401, filed Dec. 27, 2022; U.S. Provisional Patent Application No. 63/436,513 Filed Dec. 31, 2022; and U.S. Provisional Patent Application No. 63/437,263, filed Jan. 5, 2023; the contents of which are hereby incorporated by reference in their entirety.

### BACKGROUND

The present invention relates generally to the field of auxiliary power units for concrete mixer vehicles.

Concrete mixer vehicles are configured to receive, mix, and transport wet concrete or a combination of ingredients that when mixed form wet concrete to a job site. Concrete mixer vehicles include a rotatable mixing drum that receives concrete poured from vehicles or from stationary facilities, such as concrete mixing plants, and mixes the concrete disposed therein. Concrete mixer vehicles are typically driven by an onboard internal combustion engine (ICE), which may also power rotation of the mixing drum. The concrete mixer vehicle may operate the rotatable drum during times where no tractive effort is employed, and may thus operate the ICE at a low efficiency or high duty cycle, relative to a demand for tractive effort. The operation of the internal combustion engine may thus emit greenhouse gasses to rotate the drum in excess of a power demand by the vehicle.

### SUMMARY

An auxiliary power unit (APU) can power various components of a concrete mixer vehicle such as a rotatable drum during a non-operation of an internal combustion engine (ICE). For example, the APU can receive energy from an energy source such as the ICE, and employ energy received therefrom to rotate the drum. Such operation may reduce an operational time or fuel use of the ICE, which may reduce greenhouse gasses emitted therefrom. Further, the APU may interoperate with various vehicle energy sources or sinks which may further decrease a duty cycle of the ICE to mitigate greenhouse gas emissions. Such APU interoperation may further increase a utility, reliability, or interoperability of an associated concrete mixer vehicle.

One embodiment of the invention relates to a concrete mixer vehicle. The concrete mixer vehicle includes a mixer drum assembly, an energy storage device, an internal combustion engine, an auxiliary power unit, and an energy management controller. The internal combustion engine is configured to supply power to the mixer drum assembly. The auxiliary power unit is configured to supply power from the energy storage device to the mixer drum assembly. The energy management controller is configured to engage the auxiliary power unit and disengage the internal combustion engine based on a state of charge of the energy storage device.

One embodiment of the invention relates to a system. The system includes a mixer drum assembly, an energy storage device, an internal combustion engine, an auxiliary power unit, and an energy management controller. The internal combustion engine is configured to supply power to the mixer drum assembly. The auxiliary power unit is configured to supply power from the energy storage device to the mixer drum assembly. The energy management controller is configured to engage the auxiliary power unit and disengage the internal combustion engine based on a state of charge of the energy storage device.

Another embodiment of the invention relates to an energy management controller for a mixer vehicle. The energy management controller is configured to execute computer-readable instructions. The computer readable instructions can cause the energy management controller to receive a state of charge of an energy storage device. The computer readable instructions can cause the energy management controller to compare the state of charge of the energy storage device to a threshold. The computer readable instructions can cause the energy management controller to selectively engage an internal combustion engine and an auxiliary power unit, wherein each of the auxiliary power unit and the internal combustion engine are configured to supply power to a mixer drum assembly, based on the comparison.

Another embodiment of the invention relates to a concrete mixer vehicle. The concrete mixer vehicle can include a chassis having a front end and a rear end, an engine coupled to the chassis and configured to supply power to a mixer drum assembly, the mixer drum assembly coupled to the chassis, an auxiliary power unit coupled to the chassis and configured to supply power to the mixer drum assembly, and a control system communicably coupled to the auxiliary power unit and the engine, the control system configured to determine an operation status of the concrete mixer vehicle, and deactivate the engine and activate the auxiliary power unit based on the operation status.

According to some implementations, the auxiliary power unit exchanges energy with each of an electrical system and a hydraulic system. According to some implementations, the auxiliary power unit converts power between hydraulic power and electrical power. According to some implementations, the auxiliary power unit controls a speed of rotation for the mixer drum assembly based on an input received from a control assembly. According to some implementations, the control system comprises a controller configured to receive the operation status comprising an engine status or a drum drive motor status; compare the operation status to a predetermined threshold; and provide a command to engage, disengage, or adjust a power level of the auxiliary power unit responsive to the comparison. According to some implementations, the operation status comprises a power level for a drum drive motor coupled to the mixer drum assembly.

WM According to some implementations, the control system is configured to receive a location of the concrete mixer vehicle, compare the received location to another location, and adjust a power status of the auxiliary power unit based on the comparison. According to some implementations, the control system is configured to receive a battery status of an auxiliary power unit battery, and cause the auxiliary power unit to actuate or adjust a power level thereof, responsive to the battery status.

Another embodiment of the invention relates to an auxiliary power unit control system for a mixer vehicle, comprising an auxiliary power unit configured to supply power to a mixer drum assembly, and a control system communicably coupled to the auxiliary power unit and configured to send a command to one of an engine of the mixer vehicle or the auxiliary power unit to control operation of the engine or the auxiliary power unit, the control system configured to, determine an operation status of the mixer vehicle, and deactivate the engine and activate the auxiliary power unit based on the operation status.

According to some implementations, the auxiliary power unit control system is configured to cause the auxiliary power unit to exchange energy with each of an electrical system and a hydraulic system. According to some implementations, the auxiliary power unit control system is configured to cause the auxiliary power unit to convert power between hydraulic power and electrical power. According to some implementations, the auxiliary power unit control system is configured to control a speed of rotation for the mixer drum assembly based on an input received from a control assembly. According to some implementations, the auxiliary power unit control system is configured to determine the operation status comprising an engine status or a drum drive motor status, and compare the operation status to a predetermined threshold, wherein the command is configured to cause the auxiliary power unit to engage, disengage, or adjust a power level of the auxiliary power unit responsive to the comparison. According to some implementations, the operation status further comprises a power level for a drum drive motor coupled to the mixer drum assembly. According to some implementations, the auxiliary power unit control system is configured to receive a location of the mixer vehicle, compare the received location to another location, and adjust a power status of the auxiliary power unit based on the comparison.

Another embodiment of the invention relates to a concrete mixer vehicle. The concrete mixer vehicle can include a chassis having a front end and a rear end, an engine coupled the front end of the chassis, a cab coupled to the front end of the chassis, a mixer drum assembly coupled to the chassis, an auxiliary power unit coupled to the chassis and configured to supply power to the mixer drum assembly, and a control system operably coupled to the auxiliary power unit and configured to provide a command to actuate the engine, wherein the control system receives an operation status from the concrete mixer vehicle to determine a power output of the mixer drum assembly, and wherein the control system sends a command to actuate the engine between an on position and an off position in response to receiving the operation status.

According to some implementations, the control system is configured to cause actuate the auxiliary power unit. According to some implementations, the auxiliary power unit controls a speed of rotation for the mixer drum assembly based on an input received from a control assembly. According to some implementations, the control system comprises a controller configured to receive the operation status comprising an engine status or a drum drive motor status, compare the operation status to a predetermined threshold, and provide a command to engage, disengage, or adjust a power level of the auxiliary power unit responsive to the comparison. According to some implementations, the operation status further comprises a power level for a drum drive motor coupled to the mixer drum assembly.

This summary is illustrative only and is not intended to be in any way limiting. Other aspects, inventive features, and advantages of the devices or processes described herein will become apparent in the detailed description set forth herein, taking in conjunction with the accompanying figures, wherein like reference numerals refer to like elements.

### BRIEF DESCRIPTION OF THE DRAWINGS

FIG. 1A is a side view of a concrete mixer truck, according to an exemplary embodiment.

FIG. 1B is a side view of a concrete mixer truck, according to an exemplary embodiment.

FIG. 1C is a side view of a drum assembly of a concrete mixer truck, according to an exemplary embodiment.

FIG. 2 is a front perspective view of the concrete mixer truck of FIG. 1A, according to an exemplary embodiment.

FIG. 3 is a rear perspective view of the concrete mixer truck of FIG. 1A, according to an exemplary embodiment.

FIG. 4 is a top perspective view of a rearward cross-member of a chassis of the concrete mixer truck of FIG. 1A, according to an exemplary embodiment.

FIGS. 5 and 6 are various perspective views of the rearward cross-member of FIG. 4 with a battery box, according to an exemplary embodiment.

FIGS. 7 and 8 are various perspective views of a front cross-member and steering assembly of a chassis of the concrete mixer truck of FIG. 1A, according to an exemplary embodiment.

FIG. 9 is a top perspective view of the steering assembly of FIGS. 7 and 8, according to an exemplary embodiment.

FIG. 10 is a diagram of a control system for use in an auxiliary power system of the concrete mixer truck of FIG. 2, according to an exemplary embodiment.

FIG. 11 is a diagram of the control system of FIG. 10, including a gear selection status, according to an exemplary embodiment.

FIG. 12 is a diagram of the control system of FIG. 10, including a parking brake status, according to an exemplary embodiment.

FIG. 13 is a diagram of the control system of FIG. 10, including a location status, according to an exemplary embodiment.

FIG. 14 is a diagram of the control system of FIG. 10, including a battery status, according to an exemplary embodiment.

FIG. 15 is a network diagram of the control system of FIG. 10, according to an exemplary embodiment.

FIG. 16 is a unitary APU including a power unit and a storage unit, according to an exemplary embodiment.

FIG. 17 is a kit for mounting a modular unitary APU, according to an exemplary embodiment.

FIG. 18 is a bottom view of the APU of FIG. 16 coupled to the mounting kit of FIG. 17, according to an exemplary embodiment.

FIG. 19 is an isometric view of the APU of FIG. 16, according to an exemplary embodiment.

FIG. 20 is a top isometric view of the APU of FIG. 16, according to an exemplary embodiment.

FIG. 21 is another top isometric view of the APU of FIG. 16, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a concrete mixer vehicle includes a chassis, a cab, a mixer drum assembly, a chute, and a chute storage device. The chassis includes a front end and a rear end. The cab is coupled to the front end of the chassis. The mixer drum assembly is coupled to the chassis. The chute is selectively coupled to the concrete mixer vehicle and selectively repositionable between an in-use position and a storage position.

The mixer vehicle includes an auxiliary power unit (APU) coupled to the chassis. The APU is configured to control actuation of the mixer drum assembly. Specifically, the APU is configured to control the drum drive motor. The APU is operably coupled to a control system (e.g., an auxiliary power unit control system), where the control system monitors an operational status of the mixer vehicle. The operational status may include a gear selection, a parking brake position, a position of the mixer vehicle (e.g., from a global positioning system (GPS), telematics system, etc.), an auxiliary power unit battery status, or another operational characteristic of the mixer vehicle. The control system may be configured to send a command, based on the operational status, to the engine and/or the APU to determine which system will control the drum drive motor. In some embodiments, the control system may be configured to activate or deactivate the engine based on the operational status.

### Overall Vehicle

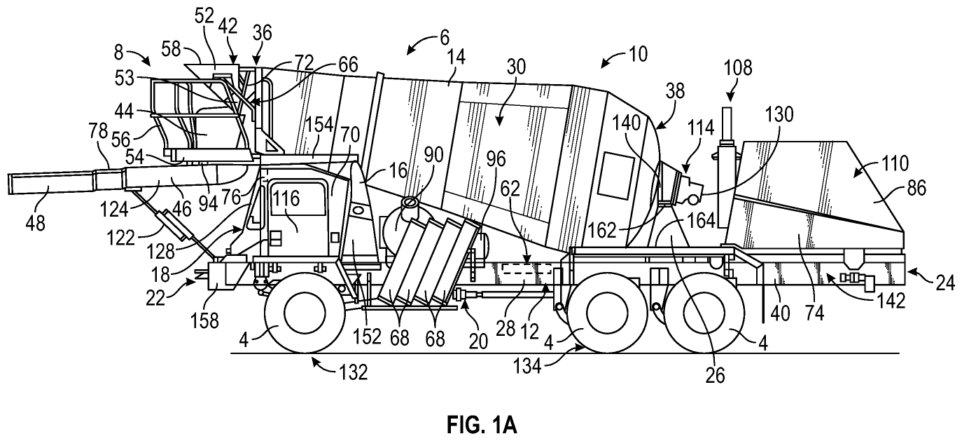

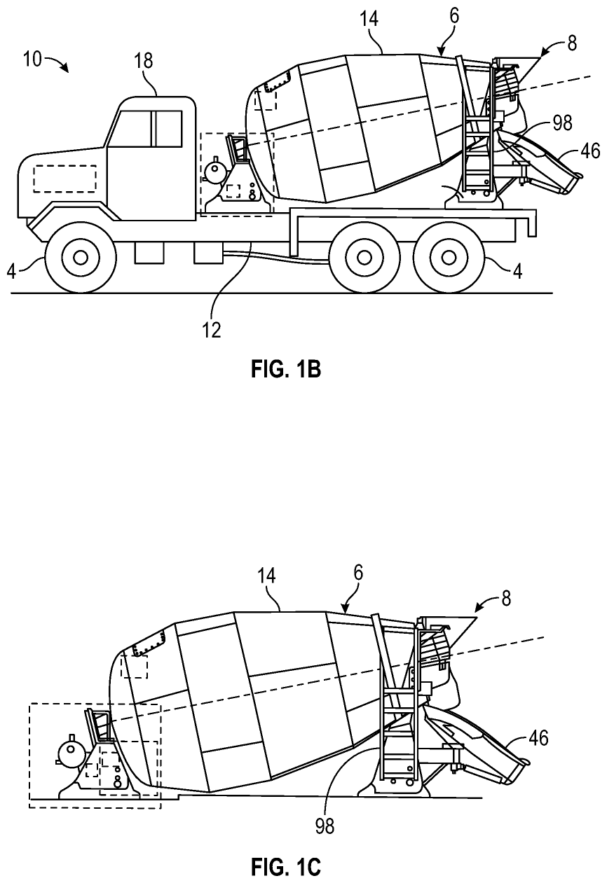

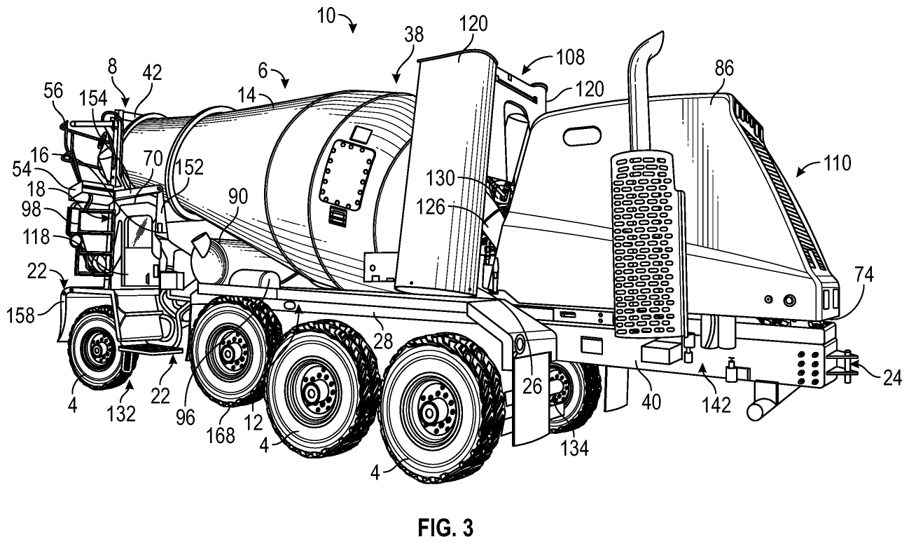

According to the exemplary embodiment shown in FIGS. 1-3, a vehicle, shown as concrete mixer truck 10, is configured to transport concrete from a loading location (e.g., a batching plant, etc.) to a point of use (e.g., a worksite, a construction site, etc.). In some embodiments, as shown in FIGS. 1A and 2-3, the mixer vehicle 10 can be a front discharge concrete mixer vehicle. In other embodiments, as shown in FIGS. 1B-1C, the mixer vehicle 10 can be a rear discharge concrete mixer vehicle. The concrete mixer truck 10 includes a chassis 12, a drum assembly 6, a hopper assembly 8, a drive system 20, a fuel system 108, and an engine module 110. The concrete mixer truck 10 may include various additional engine, transmission, drive, electronic, tractive assembly, braking, steering and/or suspension systems, and hydraulic systems that are configured to support the various components of the concrete mixer truck 10. Generally, the chassis 12 supports a mixing drum 14 of the drum assembly 6, a front pedestal 16, a rear pedestal 26, a cab 18, and the engine module 110. Each of the chassis 12, the drum assembly 6, the hopper assembly 8, the drive system 20, the fuel system 108, and the engine module 110 are configured to facilitate receiving, mixing, transporting, and delivering concrete to a job site via the concrete mixer truck 10.

The chassis 12 includes a frame 28 that extends from a front end 22 to a rear end 24 of the concrete mixer truck 10. Wheels 4 are coupled to the frame 28 and moveably support the frame 28 above a ground surface or road. The wheels 4 may be replaced by other ground engaging motive members, such as tracks. In some embodiments, the chassis 12 includes hydraulic components (e.g., valves, filters, pipes, hoses, etc.) coupled thereto that facilitate operation and control of a hydraulic circuit 1510 including a drum drive pump and/or an accessory pump. The frame 28 provides a structural base for supporting the mixing drum 14, the front pedestal 16, the rear pedestal 26, the cab 18, and the engine module 110. In some embodiments, the frame 28 includes a widened front portion that extends over and about the wheels 4 positioned at the front end 22 of the chassis 12 to simultaneously support the cab 18 and serve as a fender for the wheels 4 positioned at the front end 22 of the chassis 12. The frame 28 may include lift eyes or other structures that facilitates lifting along the chassis 12 such that the chassis 12 can be manipulated as a subassembly for assembly and/or maintenance of the concrete mixer truck 10. One Or more components may be coupled to the chassis 12 using isolating mounts made of a complaint material, such as rubber. The isolating mounts may be configured to reduce the transfer of vibrations between the components and the chassis 12.

The frame 28 includes a pair of frame rails 40 coupled with intermediate cross-members, according to an exemplary embodiment. The frame rails 40 extend in a generally-horizontal and longitudinal direction (e.g., extend within 10 degrees of perpendicular relative to a vertical direction, extend within ten degrees of parallel relative to a ground surface when concrete mixer truck 10 is positioned on flat ground, etc.) between the front end 22 and the rear end 24. The frame rails 40 may be elongated “C-channels” or tubular members, according to various exemplary embodiments. In other embodiments, the frame rails 40 include another type of structural element (e.g., monocoque, a hull, etc.). In still other embodiments, the frame rails 40 include a combination of elongated C-channels, tubular members, a monocoque element, and/or a hull element. A first frame rail 41 of the frame rails 40 may be disposed along a first lateral side 142 and a second frame rail 43 of the frame rails 40 may be disposed along a second lateral side 144, respectively, of the concrete mixer truck 10. By way of example, the first lateral side 142 of the chassis 12 may be the left side of the concrete mixer truck 10 (e.g., when an operator is sitting in the cab 18 and positioned to drive the concrete mixer truck 10, etc.) and the second lateral side 144 of the chassis 12 may be the right side of the concrete mixer truck 10 (e.g., when an operator is sitting in the cab 18 and positioned to drive the concrete mixer truck 10, etc.).

The cab 18 is coupled to the frame rails 40 proximate the front end 22 of the chassis 12. According to various embodiments, the cab 18 (e.g., operator cabin, front cabin, etc.) is configured to house one or more operators during operation of the concrete mixer truck 10 (e.g., when driving, when dispensing concrete, etc.), and may include various components that facilitate operation and occupancy of the concrete mixer truck 10 (e.g., one or more seats, a steering wheel, control panels, screens, joysticks, buttons, accelerator, brake, gear lever, etc.). The cab 18 includes a housing 70 that forms the structure of the cab 18. At least one door 116 is affixed to the housing 70 to allow an operator to enter and exit the cab 18. A windshield 128 is disposed along a front side of the housing 70, near the front end 22, and above a front bumper 158 of the concrete mixer truck 10. The windshield 128 is configured to provide visibility to the operator while driving the concrete mixer truck 10, operating a main chute 46, and completing other tasks. The front bumper 158 may be affixed to a bottom portion of the housing 70. In some embodiments, the front bumper 158 is affixed to the frame 28 at the front end 22 of the concrete mixer truck 10.

A control assembly 76 is disposed within the cab 18 and is configured to control one or more components of the concrete mixer truck 10. The control assembly 76 may include controls, buttons, joysticks, and other features that control the movement and orientation of the concrete mixer truck 10, the hopper assembly 8, the main chute 46, a charge hopper 42, a discharge hopper 44, the mixing drum 14, and/or other components of the concrete mixer truck 10. For example, the control assembly 76 may include overhead controls (e.g., in a forward overhead position) that allow an occupant of the cab 18 to toggle a switch from a ‘Close’ position to an ‘Open’ position to open and close the charge hopper 42 and/or the discharge hopper 44. In some embodiments, the control assembly 76 includes a user interface with a display and an operator input. The display may be configured to display a graphical user interface, an image, an icon, or still other information. In one embodiment, the display includes a graphical user interface configured to provide general information about the concrete mixer truck 10 (e.g., vehicle speed, fuel level, warning lights, etc.). The graphical user interface may also be configured to display a current mode of operation, various potential modes of operation, or still other information relating to a transmission, modules, the drive system 20, and/or other components of the concrete mixer truck 10.

An air tank 96 is coupled to and supported by the chassis 12 and positioned directly beneath the mixing drum 14. The air tank 96 is configured to store compressed air (e.g., for use in an air brake system, for use when raising and lowering a pusher axle assembly, etc.). A water tank 90 extends laterally across the length of the chassis 12, forward of the air tank 96. The water tank 90 is coupled to the frame rails 40 and positioned beneath the mixing drum 14. The water tank 90 may be used to supply water to wash the concrete mixer truck 10 after pouring a concrete load and/or to add water to the concrete within the mixing drum 14 at the construction site and/or during transit, among other uses.

The drum assembly 6 is configured to store, mix and dispense concrete. The drum assembly 6 includes the mixing drum 14, a drum driver 114, and the hopper assembly 8. The mixing drum 14 extends longitudinally along a majority of the length of concrete mixer truck 10 and may be angled relative to the frame rails 40 (e.g., when viewed from the side of concrete mixer truck 10). The mixing drum 14 has a first end 36 that is positioned toward the front end 22 of the concrete mixer truck 10 and coupled to the front pedestal 16 (e.g., support post, support column, etc.). The first end 36 may at least partially extend over the cab 18. The first end 36 defines a drum opening 72 in communication with the hopper assembly 8 through which concrete may flow (e.g., between the charge hopper 42, the mixing drum 14, the discharge hopper 44, the main chute 46, and extension chutes 48, etc.). The mixing drum 14 has a second end 38 that is positioned toward the rear end 24 of the concrete mixer truck 10 and coupled to the rear pedestal 26 (e.g., support post, support column, etc.). The mixing drum 14 may be rotatably coupled to front pedestal 16 (e.g., with a plurality of wheels or rollers, etc.) and rear pedestal 26 (e.g., with a drum drive transmission, etc.). Each of the front pedestal 16 and the rear pedestal 26 may be a part of a superstructure of the concrete mixer truck 10. The superstructure further includes the frame 28 and the chassis 12. In other embodiments, the mixing drum 14 is otherwise coupled to the frame rails 40.

In another embodiment, the mixer vehicle 10 can include a drum assembly 6 having a different discharge arrangement. For example, the mixer vehicle 10 can include a rear discharge. A rear discharge mixer vehicle 10 can have the mixing drum 14 with the first end 36 positioned toward the rear end 24 of the mixer vehicle 10 and coupled with the rear pedestal 26. The first end 36 can define the drum opening 72 in communication with the hopper assembly 8 through which concrete can flow. In some embodiments, the mixer vehicle 10 can include a ladder 98 that extends down from the side of the hopper assembly 8 to provide access to the first end 36 of the mixing drum 14. The mixing drum 14 can have the second end 38 positioned toward the front end 22 of the mixer vehicle 10 and coupled with the front pedestal 16.

The front pedestal 16 includes an upper portion 152 and a lower portion 154. The upper portion 152 is coupled to and supports the hopper assembly 8. The lower portion 154 is coupled to the frame rails 40 and supports the upper portion 152 of the front pedestal 16 and the first end 36 of the mixing drum 14. The rear pedestal 26 includes an upper portion 162 and a lower portion 164. The lower portion 164 is coupled to the frame rails 40 and supports the upper portion 162. The upper portion 162 supports a bottom interface of a drum drive transmission 140 (e.g., a bottom portion of the housing thereof) and/or the second end 38 of the mixing drum 14. In some embodiments, the rear pedestal 26 includes a pair of legs extending between the frame rails 40 and the drum drive transmission 140.

The drum opening 72 at the first end 36 of the mixing drum 14 is configured to receive a mixture, such as a concrete mixture, or mixture ingredients (e.g., cementitious material, aggregate, sand, etc.) such that the mixture can enter and exit an internal volume 30 of the mixing drum 14. The mixing drum 14 may include a mixing element (e.g., fins, etc.) positioned within the internal volume 30. The mixing element may be configured to (i) agitate the contents of mixture within the mixing drum 14 when the mixing drum 14 is rotated in a first direction (e.g., counterclockwise, clockwise, etc.) and (ii) drive the mixture within the mixing drum 14 out through the drum opening 72 when the mixing drum 14 is rotated in an opposing second direction (e.g., clockwise, counterclockwise, etc.). During operation of the concrete mixer truck 10, the mixing elements of the mixing drum 14 are configured to agitate the contents of a mixture located within the internal volume 30 of the mixing drum 14 as the mixing drum 14 is rotated in a counterclockwise and/or a clockwise direction by the drum driver 114.

The drum driver 114 is configured to provide an input (e.g., a torque, etc.) to the mixing drum 14 to rotate the mixing drum 14 relative to the chassis 12. The drum driver 114 may be configured to selectively rotate the mixing drum 14 clockwise or counterclockwise, depending on the mode of operation of the concrete mixer truck 10 (i.e., whether concrete is being mixed or dispensed). The drum driver 114 is coupled to a rear or base portion of the second end 38 of the mixing drum 14 and a top end of the lower portion 164 and/or a lower end of the upper portion 162 of the rear pedestal 26. The drum driver 114 includes a transmission, shown as drum drive transmission 140, and a driver, shown as drum drive motor 130, coupled to drum drive transmission 140. The drum drive transmission 140 extends rearward (e.g., toward the rear end 24 of the concrete mixer truck 10, toward the engine module 110, etc.) from the second end 38 of mixing drum 14 and the drum drive motor 130 extends rearward from drum drive transmission 140. In some embodiments, the drum drive motor 130 is a hydraulic motor. In other embodiments, the drum drive motor 130 is another type of actuator (e.g., an electric motor, etc.). The drum drive motor 130 is configured to provide an output torque to the drum drive transmission 140, according to an exemplary embodiment, which rotates the mixing drum 14 about a rotation axis. The drum drive transmission 140 may include a plurality of gears (e.g., a planetary gear reduction set, etc.) configured to increase the turning torque applied to the mixing drum 14, according to an exemplary embodiment. The plurality of gears may be disposed within a housing. In some embodiments, a drum drive pump and/or accessory pump may be configured to receive rotational mechanical energy and output a flow of pressurized hydraulic fluid to drive one or more components of the concrete mixer truck 10.

The hopper assembly 8 is positioned at the drum opening 72 of the mixing drum 14. The hopper assembly 8 is configured to introduce materials into and allow the materials to flow out of the internal volume 30 of the mixing drum 14 of the concrete mixer truck 10. The hopper assembly 8 is configured to prevent loss of material or spillage when the material enters and exits the mixing drum 14. The hopper assembly 8 includes the charge hopper 42, the discharge hopper 44, a hopper actuator 66, a platform 54, and the main chute 46, which, in a front discharge mixer vehicle 10, are positioned above at least partially forward of the cab 18 of the concrete mixer truck 10. The charge hopper 42 is configured to direct the materials (e.g., cement precursor materials, etc.) into the drum opening 72 of the mixing drum 14. The discharge hopper 44 is configured to dispense mixed concrete from the internal volume 30 of the mixing drum 14 to the main chute 46 and, ultimately, the desired location.

The platform 54 includes a perforated surface that surrounds the charge hopper 42 and the discharge hopper 44. In some embodiments, the platform 54 includes an asymmetric base. The platform 54 includes platform sides extending beneath the perforated surface. A guardrail 56 is coupled to the platform 54 and follows the contour of a periphery of the platform 54. The platform 54 is situated at a position near the drum opening 72 of the mixing drum 14 to facilitate access by the operator to the drum opening 72, the internal volume 30, the charge hopper 42, the discharge hopper 44, and/or the main chute 46. In some embodiments, the concrete mixer truck 10 includes a ladder 98 that extends downward from a side of the platform 54 to allow an operator to climb and reach the platform 54.

The charge hopper 42 includes a first portion 52 that is configured to receive materials during a charging/loading operation. The first portion 52 has a rim 58 (e.g., opening) formed at a free end of the first portion 52. The charge hopper 42 includes a second portion 53 aligned with the bottom of the first portion 52. According to an exemplary embodiment, the charge hopper 42 is selectively repositionable/movable. In some embodiments, the charge hopper 42 is configured to rotate about a horizontal, lateral axis. In some embodiments, the charge hopper 42 is configured to raise and lower vertically. Specifically, the charge hopper 42 is configured to lift, pivot, or otherwise move between a first position (e.g., a lowered position, loading position, a charging position, etc.) and a second position (e.g., a raised position, a dispensing position, a pivoted position, etc.) above or shifted from the first position. In the first position, the charge hopper 42 is configured to direct material (e.g., concrete, etc.) from a source positioned above the concrete mixer truck 10 (e.g., a batch plant, etc.) through the drum opening 72 and into the internal volume 30 of the mixing drum 14. The first position may also facilitate transport of the concrete mixer truck 10 by lowering the overall height of the concrete mixer truck 10. In the second position, the charge hopper 42 moves (e.g., lifts, pivots, etc.) away from the drum opening 72 and facilitates material flowing unobstructed out of the drum opening 72 and into the discharge hopper 44 and the main chute 46.

A hopper actuator 66 is positioned to move the charge hopper 42 between the first position and the second position. The hopper actuator 66 facilitates selectively controlling movement of the charge hopper 42 between the first position and the second position. The hopper actuator 66 is coupled to and extends between the charge hopper 42 and the platform 54. In some embodiments, the hopper actuator 66 is a hydraulic cylinder. In other embodiments, the hopper actuator 66 is another type of actuators (e.g., a pneumatic cylinder, a lead screw driven by an electric motor, an electric motor, etc.).

When receiving the material, the charge hopper 42 may be in the first position and the main chute 46 may be in a first configuration (e.g., a transport configuration, a stored configuration, etc.). Accordingly, material can be deposited into the charge hopper 42, and the charge hopper 42 directs the material into the internal volume 30 of the mixing drum 14 through the drum opening 72. While material is being added to the mixing drum 14, the drum driver 114 may be operated to drive the mixing drum 14 to agitate the material and facilitate fully loading/packing the mixing drum 14. Alternatively, the mixing drum 14 may be stationary while material is added to the mixing drum 14. When discharging and the charge hopper 42 is in the second position, the discharge hopper 44 funnels material from the mixing drum 14 into the main chute 46.

The main chute 46 functions as an outlet of the mixing drum 14 and is used to direct concrete dispensed from the internal volume 30 of the mixing drum 14 and through the discharge hopper 44 to a target location near the concrete mixer truck 10. The main chute 46 is pivotally coupled to the platform 54 and/or the discharge hopper 44 such that the main chute 46 is configured to rotate about both a vertical axis and a horizontal axis. The main chute 46 includes a base section 124 that may be pivotally coupled to the platform 54 and/or the discharge hopper 44. An extension chute 48 (e.g., a folding section, a second chute section, etc.) is pivotally coupled to the distal end of the base section 124. In some embodiments, a plurality of extension chutes 48 are pivotally connected to one another. One or more removable/detachable extension chutes 68 may be selectively coupled to the distal end of the extension chute 48.

The main chute 46 is selectively reconfigurable between a first configuration (e.g., a storage configuration, a transport configuration, etc.) and a second configuration (e.g., a use configuration, a dispensing configuration, etc.). In the first configuration, (i) the base section 124 may be selectively oriented substantially horizontal and extending laterally outward, (ii) the extension chute 48 may be selectively pivoted relative to the base section 124 and extending substantially vertically, and (iii) the removable extension chutes 68 may be removed from the extension chute 48 and stored elsewhere in the concrete mixer truck 10 (e.g., coupled to the chassis 12 beneath the mixing drum 14, etc.). In the first configuration, the main chute 46 may, therefore, minimally obscure the view of an operator positioned within the cab 18 of a front discharge mixer vehicle 10. In the second configuration, (i) the extension chute 48 may be pivoted relative to the base section 124 from the substantially vertical orientation to a substantially horizontal orientation such that the base section 124 and the extension chute 48 are aligned with one another to form a continuous path through which material can flow, and (ii) one or more of the removable extension chutes 68 may be coupled to the distal end of the extension chute 48 to increase the length of the main chute 46 (e.g., to distribute concrete further away from the concrete mixer truck 10, etc.).

A first chute actuator 122 (e.g., a chute raising/lowering actuator, etc.) is coupled to and extends between the main chute 46 (e.g., a distal end thereof, etc.) and the chassis 12. In some embodiments, the first chute actuator 122 is extends between the main chute 46 and the front bumper 158. The first chute actuator 122 is configured to raise and lower the main chute 46 to control the orientation of the main chute 46 relative to a horizontal plane (e.g., the ground, etc.). In some embodiments, the first chute actuator 122 is a pair of opposing hydraulic cylinders. In other embodiments, the first chute actuator 122 is another type of actuator (e.g., a pneumatic cylinder, a lead screw driven by an electric motor, a single hydraulic cylinder, etc.). In some embodiments, the first chute actuator 122 and the main chute 46 are both configured to rotate about the same or substantially the same vertical axis (e.g., as the main chute 46 is pivoted about the vertical axis as described in more detail herein).

A second chute actuator 94 (e.g., a chute pivot/rotation actuator, etc.) is coupled to the base section 124 of the main chute 46 and the platform 54. The second chute actuator 94 is configured to rotate the main chute 46 about a vertical axis. The second chute actuator 94 is configured to move the distal end of the main chute 46 through an arc along the left, front, and right sides of the chassis 12 (e.g., a 150 degree arc, a 180 degree arc, a 210 degree arc, etc.). In one embodiment, the second chute actuator 94 is a hydraulic motor. In other embodiments, the second chute actuator 94 is another type of actuator (e.g., a pneumatic motor, an electric motor, etc.).

A third chute actuator 78 (e.g., a chute folding/unfolding actuator, etc.) is configured to reposition (e.g., extend and retract, fold and unfold, etc.) the extension chute 48 relative to the base section 124 of the main chute 46. The third chute actuators 78 may be coupled to and extend between the base section 124 and the extension chute 48. In some embodiments, the third chute actuator 78 includes a plurality of actuators positioned to reposition a first extension chute 48 relative to the base section 124 and one or more second extension chutes 48 relative to the first extension chute 48. The first chute actuator 122, the second chute actuator 94, and the third chute actuator 78 facilitate selectively reconfiguring the main chute 46 between the first configuration and the second configuration. In some embodiments, a controller (e.g., joystick) is configured to facilitate providing commands to control operation of the first chute actuator 122, the second chute actuator 94, and the third chute actuator 78 to direct the main chute 46 and concrete flow therefrom. In some embodiments, a hopper pump may be coupled to the chassis 12 and configured to provide pressurized hydraulic fluid to power the first chute actuator 122, the second chute actuator 94, and/or the third chute actuator 78. The hopper pump may be a variable displacement pump or a fixed displacement pump. In other embodiments, a pneumatic pump and/or an electrical storage and/or generation device is used to power one or more of the first chute actuator 122, the second chute actuator 94, and/or the third chute actuator 78.

Once at the job site, the concrete mixer truck 10 may be configured to dispense the material to a desired location (e.g., into a form, onto the ground, etc.). The charge hopper 42 may be repositioned into the second position from the first position by the hopper actuator 66. The extension chute(s) 48 may be extended by the third chute actuator(s) 78 to reconfigure the main chute 46 into the second configuration from the first configuration. An operator can then couple one or more removable extension chutes 68 to the distal end of the extension chute 48 to increase the overall length of the main chute 46 (as necessary). Once the main chute 46 is in the second configuration, the operator can control the first chute actuator 122 and/or the second chute actuator 94 to adjust the orientation of the main chute 46 (e.g., about a vertical axis, about a lateral axis, etc.) and thereby direct the material onto the desired location. Once the main chute 46 is in the desired orientation, the operator can control the drum driver 114 to rotate the mixing drum 14 in the second direction, expelling the material through the drum opening 72, into the discharge hopper 44, and into the main chute 46. The operator may control the speed of the mixing drum 14 to adjust the rate at which the material is delivered through the main chute 46. Throughout the process of dispensing the material, the operator can change the location onto which the material is dispensed by varying the orientation of the main chute 46 and/or by controlling the drive system 20 to propel/move the concrete mixer truck 10.

The drive system 20 is configured to propel the concrete mixer truck 10 and may drive other systems of the concrete mixer truck 10 (e.g., the drum driver 114, etc.). The drive system 20 includes driven tractive assemblies that include a front axle assembly 132 and a pair of rear axle assemblies 134, each coupled to various wheels 4. In some embodiments, the drive system 20 includes a driveshaft coupled to the front axle assembly 132 and/or the rear axle assemblies 134. The front axle assembly 132 and the rear axle assemblies 134 are coupled to the power plant module 62 through the drive system 20 such that the front axle assembly 132 and the rear axle assemblies 134 at least selectively receive mechanical energy (e.g., rotational mechanical energy) and propel the concrete mixer truck 10. In some embodiments, a pusher axle assembly 168 (e.g., tag axle assembly, etc.) is configured to be raised and lowered to selectively engage the support surface (e.g., based on the loading of the concrete mixer truck 10, etc.). Such a configuration distributes the pressure exerted on the ground by the concrete mixer truck 10, which may be required, for example, when traveling through certain municipalities under load.

The power plant module 62 (e.g., prime mover module, driver module, etc.) is configured to supply rotational mechanical energy to drive the concrete mixer truck 10. The power plant module 62 is coupled to the chassis 12 and positioned near the longitudinal center of the concrete mixer truck 10, beneath the mixing drum 14. According to an exemplary embodiment, the power plant module 62 receives a power input from the engine module 110. In some embodiments, the power plant module 62 includes a transmission and/or an electromagnetic device (e.g., an electrical machine, a motor/generator, etc.) coupled to the transmission. In some embodiments, the transmission and the electromagnetic device are integrated into a single device (e.g., an electromechanical infinitely variable transmission, an electromechanical transmission, etc.). The electromagnetic device is configured to provide a mechanical energy input to the transmission. By way of example, the electromagnetic device may be configured to supply a rotational mechanical energy input to the transmission (e.g., using electrical energy generated from the mechanical power input provided by the engine module 110, etc.). In some embodiments, the power plant module 62 and/or the drive system 20 includes additional pumps (hydraulic fluid pumps, water pumps, etc.), compressors (e.g., air compressors, air conditioning compressors, etc.), generators, alternators, and/or other types of energy generation and/or distribution devices configured to transfer the energy from the power plant module 62 to other systems.

The fuel system 108 is configured to provide fuel to the engine module 110 and/or other components of the concrete mixer truck 10. Specifically, the fuel system 108 may be configured to provide fuel to an engine 74 of the engine module 110. The engine 74 may use the fuel in an internal combustion process to generate a mechanical power output that is provided to the power plant module 62 (e.g., to generate electricity, to power onboard electric motors used to at least one of rotate wheel and tire assemblies, to drive the transmission etc.) and/or to power the drum driver 114. The fuel system 108 may include one or more valves, hoses, regulators, filters, and/or various other components configured to facilitate providing fuel to the engine 74. The fuel system 108 includes a container 126 (e.g., a vessel, reservoir, tank, etc.) that is configured to store a fluid (e.g., fuel, air, hydraulic fluid, etc.). The container 126 is disposed behind the drum driver 114 along the chassis 12. In other embodiments, the container 126 is coupled to a side of the rear pedestal 26. In some embodiments, the container 126 is coupled to the chassis 12 and positioned directly beneath the mixing drum 14. According to an exemplary embodiment, the container 126 includes a fuel tank that stores fuel used to power the engine 74. In other embodiments, the container 126 includes an air tank configured to store compressed air (e.g., for use in an air brake system, for use when raising and lowering the pusher axle assembly 168, etc.). In some embodiments, the container 126 includes a hydraulic tank configured to store hydraulic fluid for use in one or more hydraulic circuits (e.g., a hydraulic circuit 1510 that includes the drum driver 114, etc.).

A cover assembly 120 including a plurality of cover panels is positioned between the second end 38 of the mixing drum 14 and the engine module 110. The cover assembly 120 is disposed around the fuel system 108 (e.g., the container 126, etc.), the drum driver 114, and the rear pedestal 26. The cover assembly 120 is configured to protect the various internal components from debris. Such debris may be encountered while the concrete mixer truck 10 is driven along a roadway, for example. The cover assembly 120 may also protect the various internal components from damage due to collisions with trees, poles, or other structures at a jobsite or while transporting concrete. In some embodiments, all or some of the fuel system 108 is incorporated under a hood 86 of the engine module 110.

The engine module 110 is coupled to the frame rails 40 proximate the rear end 24 of the chassis 12. The engine module 110 is configured to directly, or indirectly, supply the various components of the concrete mixer truck 10 with the power needed to operate the concrete mixer truck 10. By way of example, the engine module 110 may be configured to provide mechanical energy (e.g., rotational mechanical energy) (i) to one or more components directly (e.g., via a power-take-off, etc.) to drive the one or more components (e.g., a hydraulic pump of the drum driver 114, etc.) and/or (ii) to the power plant module 62 to drive the one or more components indirectly. The engine module 110 may be defined by any number of different types of power sources. According to an exemplary embodiment, the engine module 110 includes the engine 74 coupled to the frame rails 40 and disposed within the hood 86. The engine 74 may include an internal combustion engine configured to utilize one or more of a variety of fuels (e.g., gasoline, diesel, bio-diesel, ethanol, natural gas, etc.) to output mechanical energy. In some embodiments, at least one of the drum drive motor 130, the first chute actuator 122, the second chute actuator 94, and the third chute actuator 78 is electrically driven (i.e., powered using electrical energy) rather than hydraulically driven.

In some embodiments, the engine module 110 includes an energy storage device including a battery module (e.g., batteries, capacitors, ultra-capacitors, etc.). In other embodiments includes multiple battery modules spread throughout the concrete mixer truck 10, which cooperate to act collectively as the energy storage device. The engine module 110 can be charged through an onboard energy source (e.g., through use of an onboard generator powered by an internal combustion engine, by operating the electromagnetic device as a generator, during regenerative braking, through an onboard fuel cell, through an onboard solar panel, etc.) or through an external energy source (e.g., when receiving mains power from a power grid, etc.). In some embodiments, the concrete mixer truck 10 is a purely electric vehicle that does not include an internal combustion engine and, as such, is driven by electrical energy in all modes of operation. In such embodiments, the concrete mixer truck 10 may not include a fuel tank.

### Chassis

According to an exemplary embodiment, a frame configuration is described. The rearward cross-member configuration includes utilizing a rear cross-member and a front cross-member positioned forward of the rear cross-member to mount various concrete mixer truck components. A fluid tank is positioned between the frame rails in a lateral (e.g., transverse) direction and coupled to the front cross-member. Mounting the fluid tank between the frame rails reduces the exposure of the fluid tank to foreign objects and thereby reduces the likelihood of damage to the fluid tank. A remote fill is utilized to fill the fluid tank, and conduits to and from the tank are shortened because the fluid tank is in a central location along the chassis. A battery box is positioned between the front cross-member and rear cross-member rearward of the fluid tank. By mounting the battery box between the frame rails, the need for an additional mounting location and corresponding mounting components is eliminated, resulting in a lighter load on the chassis and reducing the number of components needed to house the batteries. Additionally, mounting the battery box in between the frame rails protects the battery box from damage. Specifically, the battery box does not extend outward from the side of the frame rail at the rear of the concrete mixer truck, like in conventional systems.

According to an exemplary embodiment, a front cross-member is described. The front cross-member is configured to couple to a steering assembly (e.g., axle assembly). This integrated design permits the steering gears to be moved rearward along the frame and placed directly a set of spring hangers, thereby reducing the front overhang of the steering assembly. By packaging all these components in a small area formed between the existing front cross-member and structure, this arrangement facilitates high steering cramp angles with large tires. Further packaging all these components together reduces the front overhang of the vehicle. Beneficially, the front cross-member is configured to be removable to facilitate access when servicing the steering assembly. The front cross-member may be configured to include a front leaf spring mounting, a chute pivot support mounting, a hydraulic chute control manifold, and a front vehicle recovery provision along with the steering assembly mounting.

According to an exemplary embodiment, an engine mount is described. The engine mount is positioned directly under the engine and couples the engine to the chassis, thereby reducing a cantilever effect on the mount. The engine mount implements a single isolator and is mounted directly to a cross-member of the chassis, thereby eliminating the need for additional cross-members, components, and mounting assemblies. Beneficially, the engine mount includes one or more chassis routings for HVAC routings, fuel filter mountings, and electrical clippings.

According to an exemplary embodiment, a routing assembly is described. The routing assembly includes an HVAC hose cluster, a tube assembly, and an electric cover that extends from the cab, along the frame rails, to the engine. Both the HVAC hose cluster and the tube assembly extend along internal portions of a respective rail in the frame rails. The routing assembly provides an organized and protected route for electrical, air, hydraulic, fuel, and HVAC connectors within the chassis, and the positions of the wires and hoses inside of the frame rails ensure that the frame rails protect these wires and hoses from exposure to foreign objects.

### Rearward Cross-Member

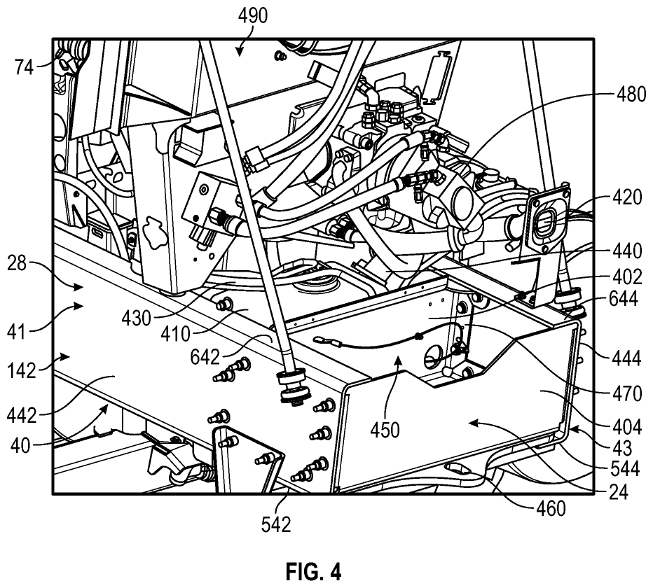

Referring to FIG. 4-6, the frame 28 includes a rearward cross-member configuration. The rearward cross-member configuration includes a pair of frame members, shown as cross-member 402 and rear cross-member 404. The cross-member 402 is positioned forward of the rear cross-member 404. As shown, the frame rails 40 each have a C-shaped cross-section (i.e., are C-channels) that includes a base and two legs oriented perpendicular to the base such that the legs define a horizontal width of the frame rail 40, and the base defines a vertical height of the frame rail 40. The first frame rail 41 on the first lateral side 142 includes a first base rail 442 (e.g., a base portion, a vertical portion, etc.), a first upper leg 642 (e.g., a horizontal portion, a protrusion, etc.), and a first lower leg 542 (e.g., a horizontal portion, a protrusion, etc.). The second frame rail 43 on the second lateral side 144 includes a second base rail 444, a second upper leg 644, and a second lower leg 544. In other embodiments, the frame rails 40 may have a different cross-sectional shape (e.g., tubular, etc.).

The cross-member 402 is coupled to the first base rail 442 and extends laterally toward, and is coupled to the second base rail 444. The cross-member 402 includes a pair of frame coupling members, shown as flanges 470, positioned on opposite ends of the cross-member 402 and coupled to an interior surface of each frame rail. Specifically, the flanges 470 may be fastened (e.g., bolted), welded, fixed, etc., to the frame rails 40. As shown, the flanges 470 are bolted to the frame rails 40. The cross-member 402 may be made from a wide variety of materials (e.g., steel, aluminum, etc.) with wide variety of cross-sections (e.g., square tube, C-channel, angle, etc.). As shown in FIGS. 4-6 the cross-member 402 is generally C-shaped with the flanges 470 positioned at each end. The cross-member 402 is positioned substantially below (e.g., directly below) a cooling system 490 and a pump 480. The cross-member 402 is offset a longitudinal distance forward of the rear cross-member 404 such that a volume, shown as cross-member cavity 450, is positioned therebetween. A horizontal plate, shown as base plate 508 is coupled to the cross-member 402, the rear cross-member 404, and the frame rails 40 and defines the bottom of the cross-member cavity 450.

The rear cross-member 404 is coupled to the first base rail 442 and extends laterally toward, and is coupled to a second base rail 444. The rear cross-member 404 includes a pair of frame coupling members, shown as flanges 470, positioned on opposite ends of the cross-member 402 and coupled to an interior surface of each frame rail. Specifically, the flanges 470 may be fastened (e.g., bolted), welded, fixed, etc., to the frame rails 40. As shown, the flanges 470 are bolted to the frame rails 40. The rear cross-member 404 may be made from a wide variety of materials (e.g., steel, aluminum, etc.) with wide variety of cross-sections (e.g., square tube, C-channel, angle, etc.). As shown in FIGS. 4-6, the cross-member 402 has a substantially flat base defining a tapered recess or opening at the top (e.g., two angled portions and a flat position disposed therebetween) and with a leg extending forward from the bottom of the base. The rear cross-member 404 is positioned at the rear end 24 of the concrete mixer truck 10.

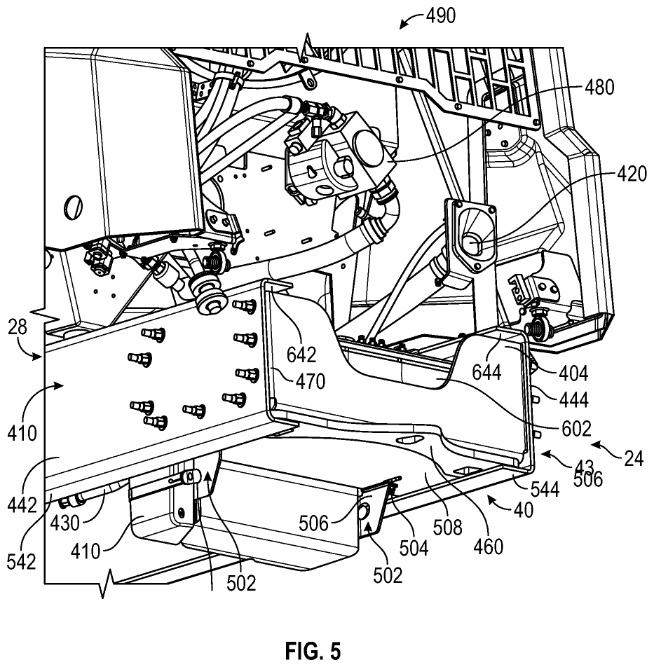

Referring to FIGS. 4 and 5, a fluid tank 410 is coupled to the frame 28. The fluid tank 410 is positioned between the frame rails 40 and extends in a lateral (e.g., transverse) direction. The fluid tank 410 is positioned forward of the cross-member 402 and is coupled to a front side of the cross-member 402. The fluid tank 410 may be further coupled to the base plate 508 disposed under the cross-member cavity 450. As shown, a pair of brackets 502 may be used to couple the fluid tank 410 to the base plate 508. A strap 506 extends around a bottom portion of the fluid tank 410 from one bracket 502 to the other bracket 502, coupling the fluid tank 410 to the brackets 502. A series of fasteners 504 couple the brackets 502 to the base plate 508. In some embodiments, the fluid tank 410 is a diesel exhaust fluid (DEF) tank. In other embodiments the fluid tank 410 contains another type of fluid (e.g., water, fuel, hydraulic fluid, etc.). The fluid tank 410 is fluidly coupled to an outlet conduit 430 configured to provide fluid to one or more components (e.g., the engine 74, through the pump 480, etc.). An inlet conduit 440 is coupled to the fluid tank 410 and defines a remote fill opening 420 disposed near the rear end 24. The remote fill opening 420 permits an operator to pour a fluid into the remote fill opening 420 to fill the fluid tank 410.

Due to the positioning of the fluid tank 410 below the pump 480 and inside of the chassis 12, conduits to and from the fluid tank 410 are shortened and are protected by the frame rails 40 and other components along the chassis 12. In some embodiments, the pump 480 is configured to provide fluid from the fluid tank 410 to one or more components along the concrete mixer truck 10. Additionally, by mounting the fluid tank 410 between the frame rails 40 it reduces the exposure of the fluid tank 410 to the environment and therefore decreases the likelihood of damage. Conventionally, concrete mixer trucks position fluid tanks outside of a set of frame rails and near an engine. In contrast, the rearward cross-member configuration provides protection to the fluid tank 410 against intrusion from a wide variety of directions due to the protection provided by the frame rails 40.

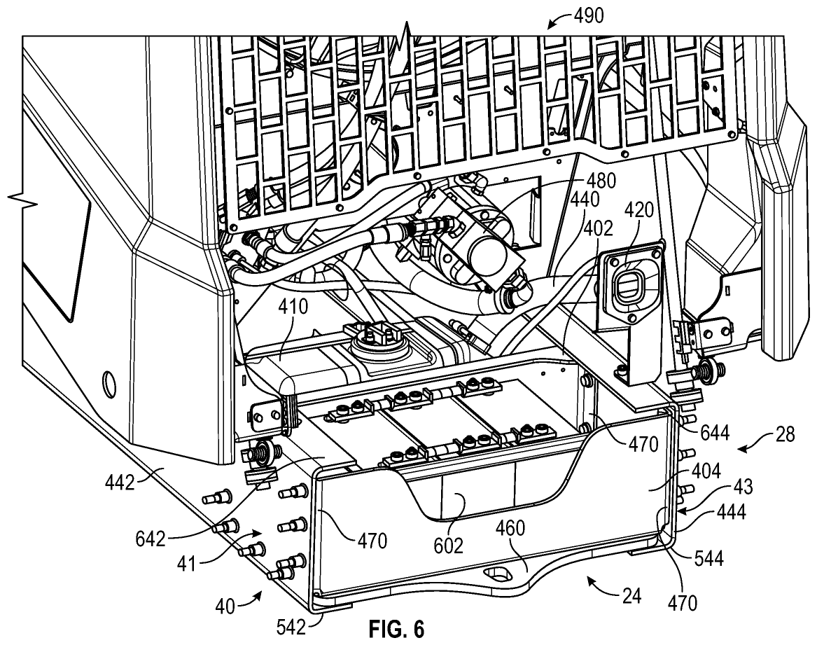

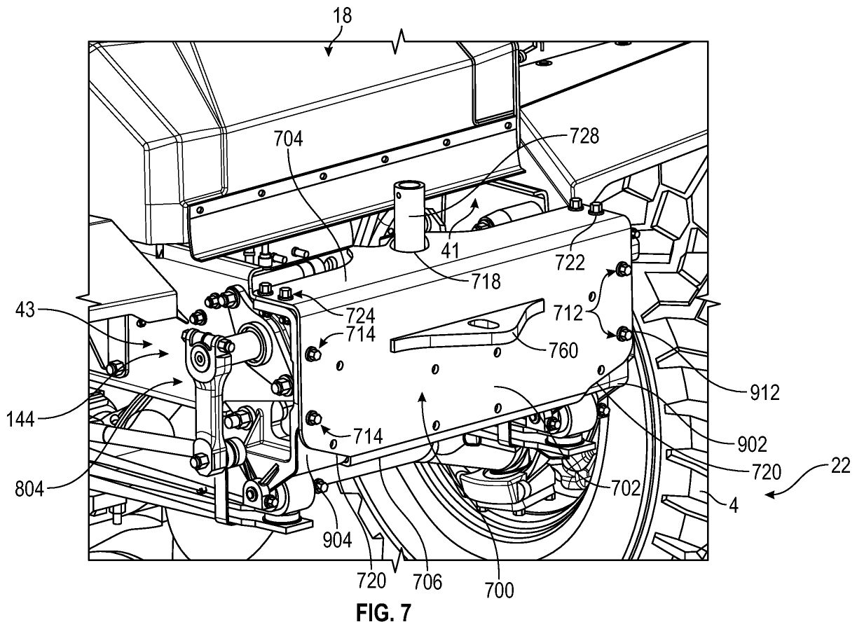

Referring to FIGS. 5 and 6, a container, shown as battery box 602, is positioned in the cross-member cavity 450 between the frame rails 40 in a lateral (e.g., transverse) direction and is coupled to the rear cross-member 404. The battery box 602 may contain or include one or more energy storage devices, such as batteries or capacitors. In some embodiments, the battery box 602 is coupled to the cross-member 402. By positioning the battery box 602 between the frame rails 40, the exposure of the battery box 602 to the environment is reduced, and therefore the likelihood of damage to the battery box 602 and the need for a separate mounting structure is eliminated. In conventional concrete mixer trucks, a battery box is mounted to an exterior surface of a frame at the rear of the concrete mixer truck. In contrast, the rearward cross-member configuration utilizes existing structures to mount the battery box 602, thereby eliminating the need for an additional mounting location and corresponding mounting components and resulting in a lighter load onto the chassis 12 and reducing the number of components needed to house the batteries in the battery box 602.

The rearward cross-member configuration provides improvements over conventional concrete mixer truck designs. The rearward cross-member configuration provides structure to the chassis 12. In some embodiments, the rearward cross-member configuration provides mounting locations (e.g., apertures) for one or more LSTA auxiliary axles. In some embodiments, the rearward cross-member configuration provides one or more lift and/or tow provisions (e.g., tow points, lift points, apertures, mounts, etc.). As shown in FIGS. 5 and 6, the base plate 508 may include a protrusion, shown as receiver 460, that extends outwardly away from the chassis 12. Specifically, the receiver 460 extends rearward of the rear cross-member 404. The receiver 460 is configured as an interface for a connection to another object (e.g., with a strap or chain), may facilitate towing (e.g., push, pull) another object, and/or for the vehicle to be towed. Specifically, the receiver 460 defines an aperture configured to receive one or more objects (e.g., hooks, straps, etc.).

### Front Cross-Member

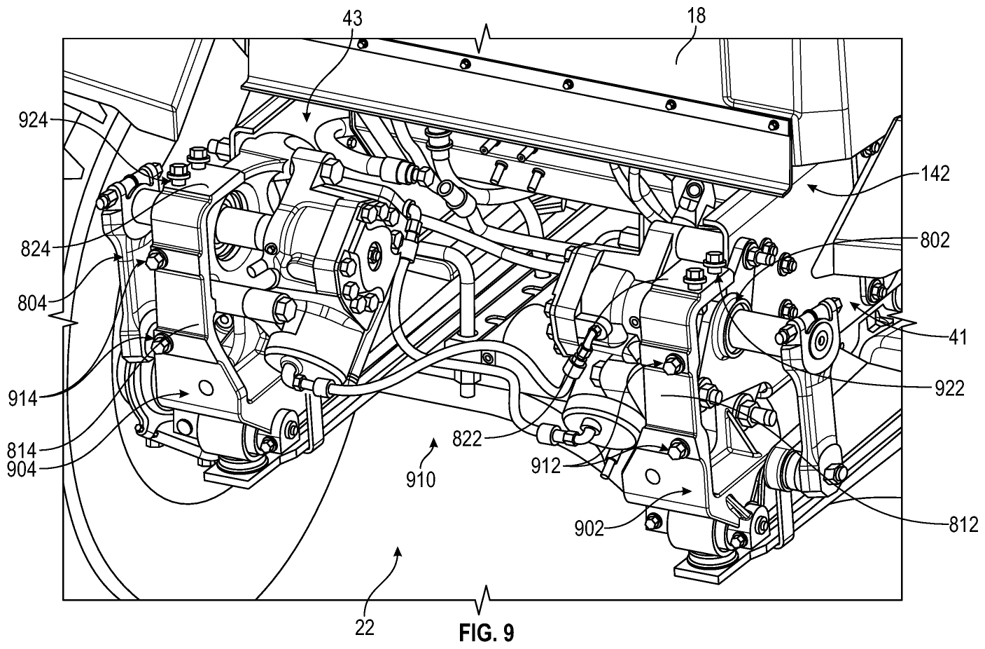

Referring to FIGS. 7-9, the frame 28 includes a frame member, shown as front cross-member 700, according to an exemplary embodiment. The front cross-member 700 is configured to couple to a steering assembly 910 along the frame rails 40. The front cross-member 700 is positioned at the front end 22 of the concrete mixer truck 10 and is coupled to the steering assembly 910 adjacent the front end 22. The front cross-member 700 includes a base 702 (e.g., a base portion, a vertical portion, etc.), an upper leg 704 (e.g., a horizontal portion, a protrusion, etc.) oriented perpendicular to the base 702, and a lower leg 706 (e.g., a horizontal portion, a protrusion, etc.) oriented perpendicular to the base 702, parallel to and offset above the upper leg 704. The front cross-member 700 has a C-channel cross-section such that the upper leg 704 and a lower leg 706 define a width of the front cross-member 700, and the base 702 defines a height of the front cross-member 700. In other embodiments, the front cross-member 700 may have a different cross-sectional shape (e.g., tubular, etc.). As shown in FIG. 9, the steering assembly 910 is included as part of a first wheel assembly 802 and a second wheel assembly 804. The wheel assembly 802 and the wheel assembly 804 are configured to be connected with a drive shaft of the vehicle, receiving rotational energy from the engine 74 (e.g., prime mover) and allocating torque provided by the engine 74 between the half shafts and/or wheel assemblies. The half shafts and/or wheel assemblies deliver the rotational energy to each wheel-end assembly.

The first wheel assembly 802 includes a first wheel bracket 902 and may include various components of the drive system 20 including brakes, a gear reduction, steering components, a wheel hub, a wheel, and other features. The first wheel bracket 902 includes a first bracket face 812 and a first bracket leg 822. The first bracket face 812 is coupled to a pair of first front coupling members 912 (e.g., fasteners, bolts, etc.). The first bracket leg 822 is coupled to a pair of first upper coupling members 922 (e.g., fasteners, bolts, etc.). The second wheel assembly 804 includes a second wheel bracket 904 and may include various components of the drive system 20 including brakes, a gear reduction, steering components, a wheel hub, a wheel, and other features. The second wheel bracket 904 includes a second bracket face 814 and a second bracket leg 824. The second bracket face 814 is coupled to a pair of second front coupling members 914 (e.g., fasteners, bolts, etc.). The second bracket leg 824 is coupled to a pair of second upper coupling members 924 (e.g., fasteners, bolts, etc.).

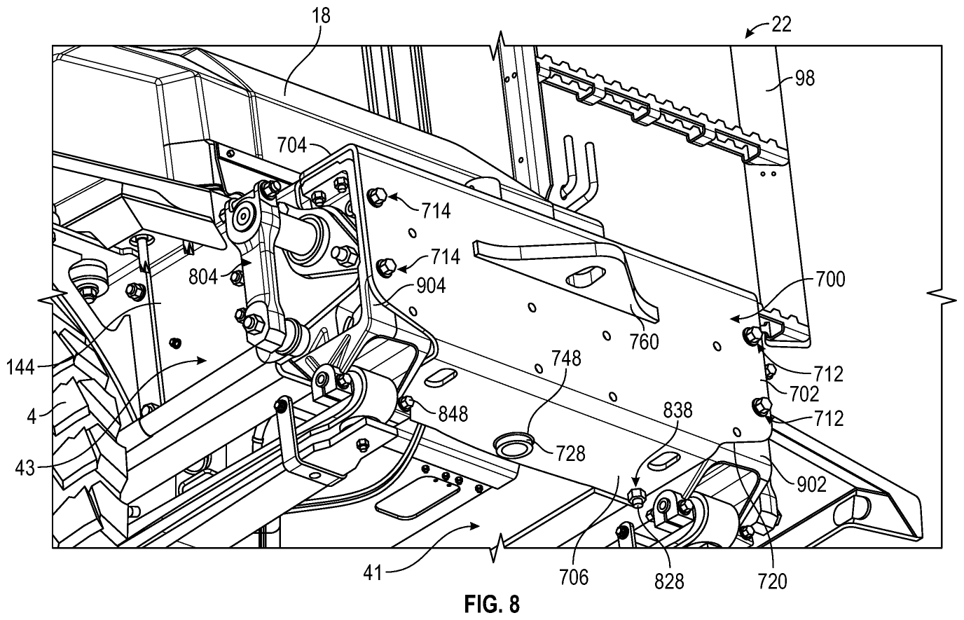

The base 702 includes a bottom portion 720 that tapers and curves as the base 702 transitions to the lower leg 706. As shown in FIG. 8, the bottom portion 720 is configured to fit the lower shape and components of the steering assembly 910, including the first wheel assembly 802 and a second wheel assembly 804. The base 702 is coupled to a protrusion, shown as receiver 760, that extends outwardly away from the chassis 12. Specifically, the receiver 760 extends forward of the base 702. The receiver 760 is configured as an interface for a connection to another object (e.g., with a strap or chain). The receiver 760 may facilitate towing (e.g., push, pull) another object and/or may facilitate towing the concrete mixer truck 10. As shown, the receiver 760 defines an aperture (e.g., a vertical aperture) configured to receive another object (e.g., a hook, a strap, etc.). The base 702 defines a first front set of holes 712 or apertures adjacent to the first lateral side 142. The first front set of holes 712 are configured to receive the first front coupling members 912 of the first wheel bracket 902. The base 702 includes a second front set of holes 714 or apertures adjacent to the second lateral side 144. The second front set of holes 714 are configured to receive the second front coupling members 914 of the second wheel bracket 904. The shape of the base 702 is complementary to the shape of the first bracket face 812 and the second bracket face 814 such that the base 702 engages the first bracket face 812 and the second bracket face 814.

The upper leg 704 defines a shaft opening 718 or aperture positioned centrally and configured to receive an actuator shaft 728. The actuator shaft 728 is configured to couple with the first chute actuator 122 to move the main chute 46. The upper leg 704 defines a first upper set of holes 722 or apertures adjacent to the first lateral side 142. The first upper set of holes 722 are configured to receive the first upper coupling members 922 of the first wheel bracket 902. The upper leg 704 defines a second upper set of holes 724 or apertures adjacent to the second lateral side 144. The second upper set of holes 724 are configured to receive the second upper coupling members 924 of the second wheel bracket 904. The shape of the upper leg 704 is complementary to the shape of the first bracket leg 822 second bracket leg 824 such that the upper leg 704 engages the first bracket leg 822 second bracket leg 824.

The lower leg 706 defines a shaft opening 748 or aperture positioned centrally and configured to receive the bottom portion of the actuator shaft 728. The actuator shaft 728 is supported by and able to rotate within the shaft opening 748 and the shaft opening 718 of the upper leg 704. The lower leg 706 defines one or more lower holes 838 or apertures adjacent to the first lateral side 142. The lower holes 838 are each configured to receive a coupling member 828 (e.g., a fastener, a bolt, etc.) that couples the lower leg 706 to a bottom surface of one of the frame rails 40. The shape of the lower leg 706 is complementary to the shape of the frame rails 40 such that the lower leg 706 engages the frame rails 40.

As shown in FIGS. 7-9, the integrated design of the front cross-member 700 facilitates moving the steering assembly 910 rearward along the concrete mixer truck 10 and placed directly above spring hangers, thereby reducing the overhang on the front end 22. Additionally, the relatively close spacing between the front cross-member 700 and the steering assembly 910 components in a small area facilitates having high steering cramp angles with large tires. As shown in FIG. 9, the front cross-member 700 is removable (e.g., by unscrewing the coupling members from the holes) to allow for easy servicing of the steering assembly 910 components and other components of the drive system 20. In some embodiments, the front cross-member 700 may be configured to include a front leaf spring mounting, a chute pivot support mounting, a hydraulic chute control manifold, and a front vehicle recovery provision along with the steering gear mounting.

### Auxiliary Power Unit

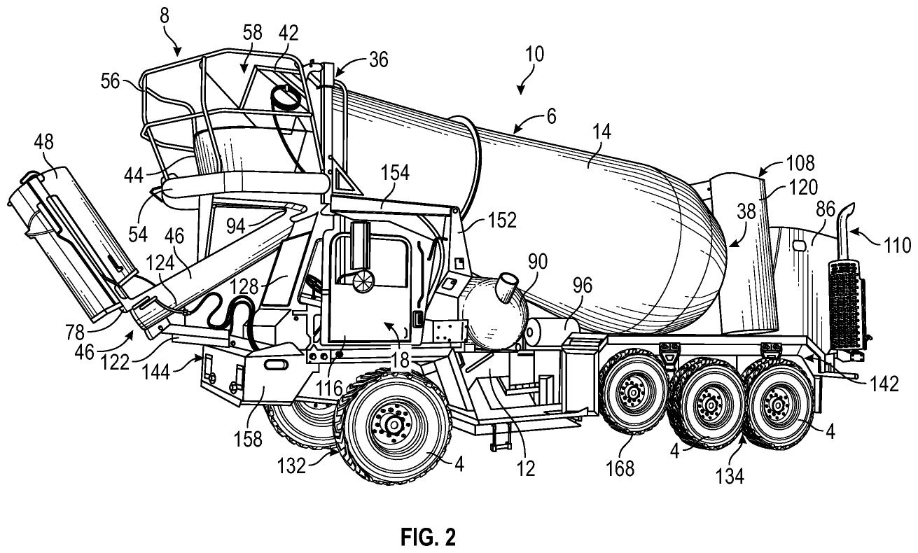

Referring now to FIG. 2, the mixer vehicle 10 includes an auxiliary power unit (APU) 1000 coupled to the chassis 12 of the mixer vehicle 10. In other embodiments, the APU 1000 may be detachably coupled to the mixer vehicle 10. The APU 1000 may be coupled to the chassis 12 between a set of wheels 4. In other embodiments, the APU 1000 may be coupled to the chassis 12 distal a set of wheels 4. The APU 1000 provides power to one or more components of the mixer vehicle 10. In some embodiments, the power is hydraulic power. In other embodiments, the APU 1000 may provide electric power. In some embodiments, the APU 1000 receives electrical power from an energy storage and/or generation system. In some embodiments, the APU 1000 includes batteries or other energy storage elements. For example, the APU 1000 may be integrated with or power a mixer drum coupled to the mixer vehicle 10. It should be understood that the APU 1000 can be mounted anywhere on the mixer vehicle 10.

In some embodiments, the APU 1000 integrates or otherwise combines an electrical and a hydraulic system. For example, the APU 1000 may provide electrical power to a motor to power the drum drive motor 130 and provide hydraulic power to an actuator of the discharge chute. Additionally or alternatively, the APU 1000 may convert power from one system to another system. For example, the APU 1000 may convert hydraulic power to stored potential energy for an electrical motor. As a further example, the APU 1000 may convert stored electrical power into hydraulic power for a hydraulic system. In some embodiments, the auxiliary power system is or includes a power take-off.

The APU 1000 is configured to provide, or otherwise supply, power to the drum drive motor 130. According to various exemplary embodiments, the APU 1000 may provide power to accessory components of the mixer truck 10. The APU 1000 may be configured to supply power to accessory components of the mixer truck 10 (e.g., discharge chute, etc.), where it would otherwise be inefficient to actuate the engine 74 to provide power.

The APU 1000 is operably coupled to at least the drum drive motor 130, where the APU 1000 may control actuation of the drum drive motor 130 between an on (e.g., activated, etc.) and an off (e.g., deactivated) state. The APU 1000 may also control a speed of the drum drive motor 130. In some embodiments, the APU 1000 maybe operably coupled to the engine 74. In other embodiments, the APU 1000 may be operably coupled to secondary components of the mixer vehicle 10. For example, the APU 1000 may be operably coupled to the fuel system 108 to alter the delivery of fuel to the engine 74. As will be discussed in greater detail herein, the APU 1000 receives data from an auxiliary power unit control system to actuate the APU 1000 into an on position or an off position.

### Auxiliary Power Unit Control System

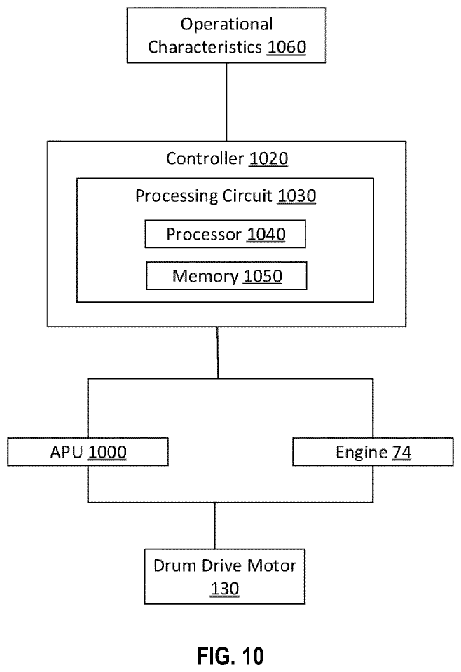

Referring now to FIG. 10, the APU 1000 is controlled via a control system 1010. The control system 1010 may be configured to operate the mixer vehicle 10, according to an exemplary embodiment. The control system 1010 includes a controller 1020 that is configured to generate control signals for the engine 74 and the APU 1000. In other embodiments, the controller 1020 is also configured to generate control signals for other components of the drivetrain, the chassis, etc., of the mixer vehicle 10.

The controller 1020 may include a circuit, shown as processing circuit 1030, a processor, shown as processor 1040, and memory, shown as memory 1050, according to an exemplary embodiment. The controller 1020 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. The processing circuit 1030 may include an ASIC, one or more FPGAs, a DSP, circuits containing one or more processing components, circuitry for supporting a microprocessor, a group of processing components, or other suitable electronic processing components (i.e., processor 1040). In some embodiments, the processing circuit 1030 is configured to execute computer code stored in memory 1050 to facilitate the activities described herein.

The memory 1050 may be any volatile or non-volatile computer-readable storage medium capable of storing data or computer code relating to the activities described herein. According to an exemplary embodiment, the memory 1050 includes computer code modules (e.g., executable code, object code, source code, script code, machine code, etc.) configured for execution by the processing circuit 1030.

In some embodiments, a single controller 1020 is configured to generate control signals for both the engine 74 and the drum drive motor 130. In other embodiments, multiple controllers 1020 are configured to generate control signals for the engine 74 and the drum drive motor 130 independently of each other.

Referring still to FIG. 10, the controller 1020 is operably coupled to at least the engine 74, the drum drive motor 130, and the APU 1000. The controller 1020 is further configured to monitor a status of the drum drive motor 130. In some embodiments, the controller 1020 is configured to monitor a status of the engine 74. In other embodiments, the controller 1020 is also configured to monitor a status of other components of the mixer vehicle 10, and/or other operational characteristics of the mixer vehicle. For example, the controller 1020 may be communicably coupled with a telematics and/or GPS system and may be configured to receive a location of the mixer vehicle from the telematics and/or GPS system (e.g., GPS coordinates, etc.).

In at least one embodiment, the controller 1020 is configured to monitor an operation status of the drum drive motor 130 (e.g., motor on, motor off, motor speed, etc.). Alternately, or in combination, the controller 1020 may be configured to monitor an operation state of the engine 74 (e.g., engine on, engine off, engine temperature, etc.). The drum drive motor status, engine status, and/or other operational characteristics of the mixer vehicle may be provided to the controller 1020 via a communications interface (e.g., via a wired or wireless connection with other vehicle components and sensors).

Once the controller 1020 receives the operational status (e.g., at least one of the engine status and the drum drive motor status), the controller 1020 further compares the received operational status to stored data within the controller 1020. For example, the controller 1020 may compare the operational status to data stored within the memory 1050. In response, the controller 1020 may provide a command back to the APU 1000 and/or engine 74. The command may be one of at least a power on, power off, increase power, decrease power, maintain power, or the like. By way of example, the controller 1020 may determine that the drum drive motor 130 requires more power and, in response, activates or otherwise controls the engine 74 and/or the APU 1000 to provide the required power to the drum drive motor 130. The determination of which of the engine 74 and the APU 1000 will provide the power may be based upon the calculated power needs from the drum drive motor 130 and/or other operational characteristics. By way of example, the controller 1020 may determine that the drum drive motor 130 requires more power input than what the APU 1000 can provide and, in response, activates the engine 74 to provide the required power. In another example, the controller 1020 may determine that the drum drive motor 130 requires a power that is within the power output range of the APU 1000 and, in response, activates the APU 1000 and deactivates the engine 74 to provide the required power. In another example, the controller 1020 may send a command to actuate both the engine 74 and the APU 1000 at the same time to provide the required power to the drum drive motor 130.

Referring still to FIG. 10, the control system 1010 is configured to receive the operational characteristic 1060 of the mixer vehicle from one or more sensors and/or control modules onboard the mixer vehicle.

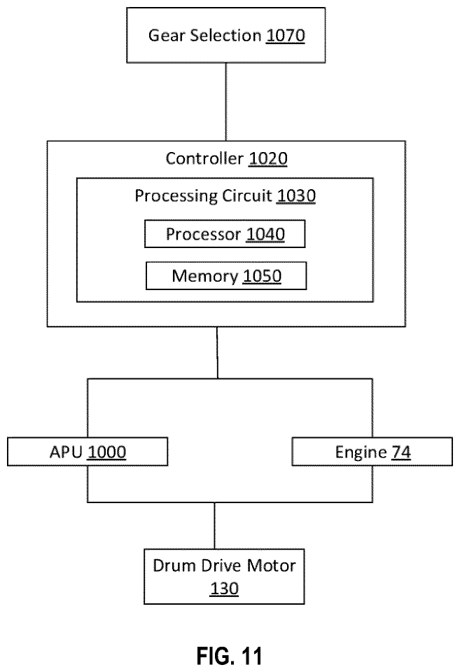

Referring to FIG. 11, the operational characteristic may be a gear selection 1070. In such an embodiment, the controller 1020 may monitor the gear selection 1070 of a transmission, where the gear selection 1070 may determine actuation of the engine 74 and/or the APU 1000. In some embodiments, the gear selection 1070 may determine actuation of the drum drive motor 130. For example, the controller 1020 may receive data signaling that the transmission is operating at a high gear ratio and, in response, the controller 1020 sends a command back to the engine 74 to actuate the engine 74 into an on status or an increased power status. In another example, the controller 1020 may receive data signaling that the transmission is operating at a low gear ratio and, in response, the controller 1020 send a command back to the APU 1000 to actuate the APU 1000 into an on status or an increased power status. As can be appreciated, when the engine 74 is in the on position, the APU 1000 may be in the off position. Furthermore, when the APU 1000 is in the on position, the engine 74 may be in the off position. Alternatively, both the engine 74 and the APU 1000 may simultaneously be in the on position or the off position.

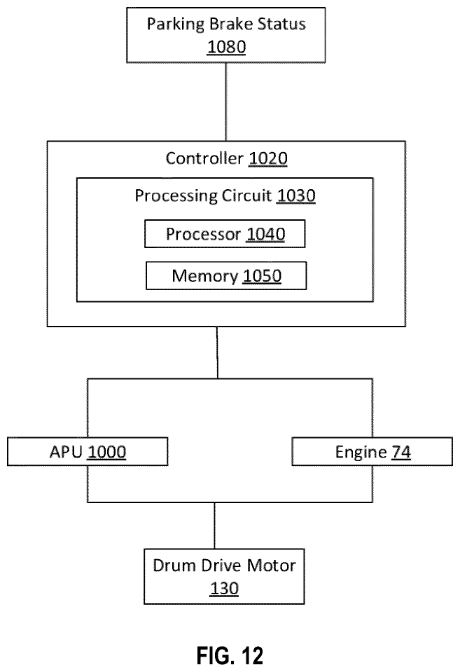

Referring now to FIG. 12, the operational characteristic may be a parking brake position 1080. In such an embodiment, the controller 1020 may monitor the parking brake position 1080, where the parking brake position 1080 may determine how the controller 1020 operates the engine 74 and/or the APU 1000. For example, the controller 1020 may receive data signaling that the parking brake position 1080 is in an engaged position and, in response, the controller 1020 sends a command back to the APU 1000 to actuate the APU 1000 into the on position or the increased power status. In another example, the controller 1020 may receive data signaling that the parking brake position 1080 in in a disengaged positon and, in response, the controller 1020 may send a command back to the engine 74 to actuate the engine 74 into the on status or the increased power status. As should be appreciated, when the engine 74 is in the on position, the APU 1000 may be in the off position. Furthermore, when the APU 1000 is in the on position, the engine 74 may be in the off position. Alternatively, both the engine 74 and the APU 1000 may simultaneously be in the on position or the off position.

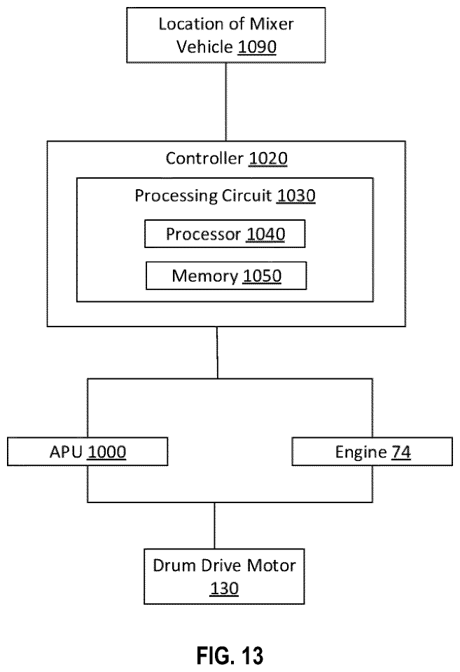

Referring now to FIG. 13, the operational characteristic may be a location 1090 of the mixer truck 10. The controller 1020 may monitor the location 1090 of the mixer truck 10. The position may be monitored using systems such as a global positioning system (GPS), or the like. In such an embodiment, the controller 1020 may monitor the location 1090 of the mixer truck 10, where the location 1090 may determine how to operate the engine 74 and/or the APU 1000. For example, the controller 1020 may receive a location 1090 indicating that the mixer truck has arrived at a job site and, in response, send a command to the APU 1000 to actuate the APU 1000 into the on status or the increased power status. In another example, the controller 1020 may receive a location 1090 indicating that the mixer truck 10 is in motion, and, in response, send a command to the engine 74 to actuate into the on status or the increased power status. In some embodiments, the APU 1000 may be in the on status or the increased power status when the mixer truck 10 is in motion. As can be appreciated, when the engine 74 is in the on position, the APU 1000 may be in the off position. Furthermore, when the APU 1000 is in the on position, the engine 74 may be in the off position. Alternatively, both the engine 74 and the APU 1000 may simultaneously be in the on position or the off position.

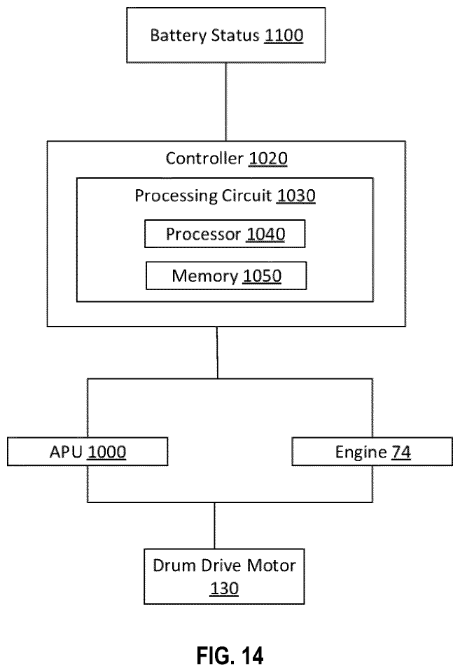

Referring to FIG. 14, the operational characteristic may be a battery status 1100. In such an embodiment, the controller 1020 may monitor the battery status 1100 (e.g., battery charge level, battery output level, etc.), and control at least one of the engine 74 and/or the APU 1000 based on the battery status 1100. In some embodiments, controller 1020 may also control the drum drive motor 130 based on the battery status 1100. For example, the controller 1020 may receive the battery status 1100 indicating that the battery is in normal operating conditions and, in response, send a command to the APU 1000 to actuate the APU 1000 into the on status or the increased power status. In another example, the controller 1020 may receive the battery status 1100 indicating that the battery is not within normal operating conditions and, in response, send a command to the engine 74 to actuate into the on status or the increased power status. As can be appreciated, when the engine 74 is in the on position, the APU 1000 may be in the off position. Furthermore, when the APU 1000 is in the on position, the engine 74 may be in the off position. Alternatively, both the engine 74 and the APU 1000 may simultaneously be in the on position or the off position.

In some embodiments, the controller 1020 may also be configured to control the APU 1000 and/or engine 74 based on other operational characteristics including, for example, a commanded speed of the mixer drum (e.g., based on operator inputs, etc.), a position and/or control command issued to the discharge shoot, and/or other operational characteristics.

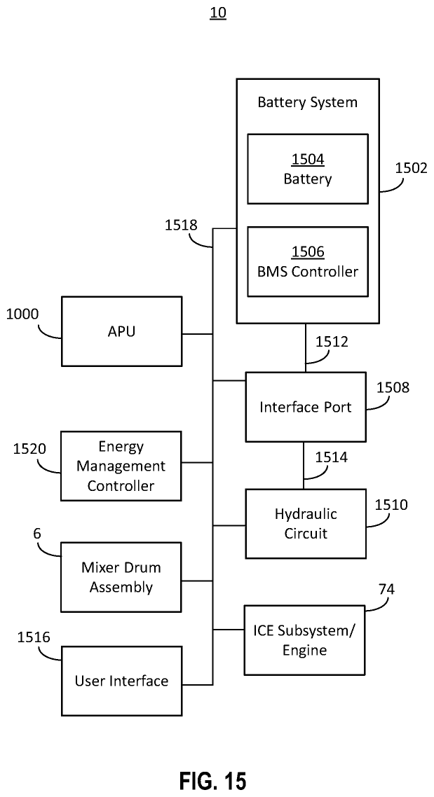

Referring to FIG. 15, a network diagram of the control system for the mixer vehicle 10 of FIG. 10 is shown, according to an exemplary embodiment. The mixer vehicle 10 can include various subsystems storing, generating, receiving, or delivering power to or from the mixer vehicle 10, or between various components of the mixer vehicle 10. The mixer vehicle 10 can include a fluidic circuit such as a pneumatic circuit or a hydraulic circuit 1510 (e.g., fluidic cylinders, pumps, lines and the like). The mixer vehicle 10 can include a battery system comprising a battery management system (BMS) controller 1506 and a battery 1504 and/or battery pack, an internal combustion engine (ICE) subsystem, (which may include or be referred to as an engine 74, herein), an interface port 1508 (e.g., charging port), or the like. The mixer vehicle 10 can include a mixer drum assembly 6 to rotate or mix concrete (e.g., by a drum drive motor 130 thereof, based on power supplied thereto by the ICE or APU 1000). The mixer vehicle 10 can include an APU 1000 to interface with or between various subsystems, such as to convey communications or energy therebetween. In some embodiments, various components can be substituted between subsystems. For example, pumps, rotatable or linearly actuated devices, or energy storage devices can employ electrical power or hydraulic power according to various implementations, and may be interchanged according to an electrical or hydraulic capacity employed by a mixer vehicle 10.

The APU 1000 may include, interface with or otherwise employ an energy management controller 1520. The energy management controller 1520 may monitor, adjust, convey, or depict a status of energy use throughout the mixer vehicle 10. The energy management controller 1520 can include, interface with, or share one or more components with another controller of the vehicle, such as the controller 1020 of FIG. 10, a battery management system (BMS) controller 1506, or various sensors or interfaces to monitor or control vehicle components such as a FLEX™ body control system. As described herein, the energy management controller 1520 can monitor or control various energy flows of the mixer vehicle 10. For example, the energy management controller 1520 can engage an alternator, power-take-up, or other energy conversion devices between the various subsystems, or may detect a position of a manually engaged device.

The energy management controller 1520, BMS controller 1506, or other controllers of the mixer vehicle 10 may include a circuit (e.g., a processing circuit), a processor, and memory. The controllers may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. The processing circuit may include an ASIC, one or more FPGAs, a DSP, circuits containing one or more processing components, circuitry for supporting a microprocessor, a group of processing components, or other suitable electronic processing components (i.e., processor). In some embodiments, the processing circuit is configured to execute computer code stored in memory to facilitate the activities described herein. For example, each controller can interface with or include a processing circuit 1030, processor 1040, or memory 1050 as is further described with regard to the controller 1020 of FIG. 10.

The APU 1000 can include or interface with a battery system 1502, hydraulic circuit 1510, or the energy management controller 1520. The APU 1000 can employ energy from the battery system 1502, auxiliary power supply, compressed air tank, hydraulic energy storage device, or energy supply device. A maximum, average, or sustained power delivered to the mixer drum assembly 6 may vary according to a state of the energy storage device or energy supply device. Moreover, the maximum, average, or sustained power delivered to the mixer drum assembly 6 may vary from the power delivered by an ICE. A maximum rotational speed, tilt angle, or the like can vary according to a power level delivered to the mixer drum assembly 6, or a mixture disposed within the drum (e.g., an amount, composition, or homogeneity thereof). Thus, various speeds provided herein may be adjusted upwards or downwards according to a tilt angle or content of the mixer drum assembly 6. For example, upon a receipt of cement and aggregate, or other non-homogenous concrete mixture, the mixer drum assembly 6 can engage in a mixing process to combine (e.g., homogenize) the mixture a first speed or tilt angle, and may thereafter maintain the mixture at a second first speed or tilt angle, different from the first.

The mixer drum assembly 6 can include blades (which may also be referred to as fins) such as a spiral auger or spiral blades coupled to and disposed within the drum. The APU 1000 can cause the blades to rotate and thereby lift material from within the drum and allow the material to fall back into the mixture. The tilt angle can be controlled based on a vehicle position (e.g., parking on an inclined surface), or an inclination of the rotational axis of the mixer relative to the vehicle chassis 12. The power supplied to the mixing assembly can vary according to the tilt angle or rotational speed. For example, shallower tilt angles may lift material in the drum higher, which may increase a mixing of the material disposed within the drum, but may employ increased power. Moreover, rotating the drum at relatively high speeds (e.g., at or in excess of 10 rotations per minute (RPM), such as 15 RPM) may employ higher power than rotating the drum at relatively low speeds (e.g., less than 10 RPM, such as between 2 RPM and 6 RPM). For example, during ICE operation, the mixer drum assembly 6 may rotate at or in excess of 10 RPM, such as 15 RPM or the like. Such rotation can homogenize a mixture disposed therein. During non-ICE operation, the APU 1000 can rotate the drum at a lower rate, or a greater tilt. Such operation at a relatively low speed during transportation of premixed concrete can maintain the properties of the concrete.

The APU can employ an infinitely variable control of the rotational speed (e.g., according to an analog control signal) or a finite number of steps according to a digital signal (e.g., according to a digital value such as an 8-bit value, 16-bit value or the like). The finite number of steps can be adjusted based on a user control or a control signal generated by the energy management controller 1520. In some embodiments, the control signal can control a torque or power applied to the mixer drum assembly 6 such that the rotational speed of the drum can vary according to a content or position of the drum. In some embodiments, the control signal can control the speed, such as by modulating the torque or power applied to the mixer drum assembly 6.

According to some embodiments, an ICE can be employed to rotate the mixer drum assembly 6 during relatively high speed operation. The APU 1000 may be employed to rotate the mixer drum assembly 6 during lower speed operation. For example, the APU 1000 may rotate the mixer drum assembly 6 at a variable speed, such as between 2 RPM and 10 RPM. The rotational speed of the mixer drum assembly 6 absent ICE operation may be less than the mixer drum assembly 6 during ICE operation. The relative speed during APU operation may vary according to a power delivered by the APU 1000 and a power delivered by an ICE. For example, during non-operation of the ICE, the APU 1000 may rotate the drum at a speed that is at least 50% of a speed realizable during ICE operation.

According to some embodiments, the APU 1000 can rotate the mixer drum assembly 6 in combination with the ICE. The combination of the APU 1000 and the ICE can rotate the mixer drum assembly 6 at a speed which is greater than the APU 1000 or the ICE alone. In some embodiments, the APU 1000 may be employed to reduce a load on the ICE (e.g., to reduce a fuel use or emission thereof). For example, the energy management controller 1520 can cause the ICE to operate in an efficiency band (e.g., between 1000 and 2000 RPM), such as by control of a throttle of the ICE, or the like. The APU 1000 can contribute power to rotating the mixer drum assembly 6 to prevent ICE excursions above the efficiency band, and receive power sourced from the ICE to prevent ICE excursions below the efficiency band. The energy management controller 1520 can cause the ICE to shutoff or startup according to a state of charge (SoC) of an energy storage device associated with the APU 1000 (e.g., can shut off the ICE when a battery SoC exceeds a threshold and startup the ICE when the battery SoC falls below another threshold).

The APU 1000 output power can vary according to a SoC of an energy storage device associated therewith. For example, the energy management controller 1520 can monitor a status of a battery SoC, hydraulic or pneumatic SoC (e.g., pressure), or the like, and determine a maximum power output based on the SoC. In some embodiments, the APU 1000 can interface with modular pumps, batteries, or other components. The energy management controller 1520 may further determine the maximum power output based on the identity of the components, such as based on a user input, a vehicle configuration identity, or the like received via the user interface 1516, or based on network communication with the various components. In some embodiments, the APU 1000 can maintain a normalized power output, such as by a boost controller to maintain an output voltage. The energy management controller 1520 can indicate that an SoC associated with an APU 1000 is insufficient to provide the normalized power output. For example, the energy management controller 1520 can receive a request to rotate a mixer drum assembly 6 at 3 RPM. Responsive to the request, the energy management controller 1520 can determine if the SoC is sufficient to rotate the mixer drum assembly 6 at 3 RPM, or compare the SoC to another predefined threshold (e.g., a threshold which is associated with rotating the mixer drum assembly 6 at 10 RPM). The energy management controller 1520 can convey an indication of the SoC or take an action based on the SoC (e.g., engage an ICE in increase a SoC).

In some embodiments, the APU 1000 can interface with various hydraulic components of the mixer vehicle 10. For example, the APU 1000 can tee into the hydraulic circuit 1510 to exchange hydraulic power with various devices of the hydraulic circuit. The interconnection of the APU 1000 and the hydraulic circuit 1510 can include one or more heat exchangers shared between the APU 1000 and the hydraulic circuit 1510 including any of the hydraulic devices disclosed herein (e.g., a truck oil cooler).

One or more check valves can intermediate the APU 1000 and other hydraulic devices of the mixer vehicle 10. For example, a check valve can intermediate the APU 1000 and the ICE (e.g., a power-take off thereof) such that the APU 1000 can apply a hydraulic force to the hydraulic circuit 1510 to cause a rotation of the drum assembly 6. Such a check valve can prevent the fluid force from causing a rotation of the power-take-off, and the ICE. In some embodiments, a pilot operated check valve may be employed which may prevent back flow through various devices of the hydraulic circuit 1510. For example, a gear pump can include bypass valves or gears to pass flow through the pump without actuating the pump. In some embodiments, the pilot check valve can be configured as a double pilot check valve to permit selectable flow direction. For example, the energy management controller 1520 can cause the APU 1000 to provide power to other devices of the hydraulic circuit 1510, or to receive power therefrom. The APU 1000 can employ received power according to the various disclosures provided herein, such as to generate electrical power, start the ICE, provide pneumatic or electrical power, and so forth.

The APU 1000 may provide power to various vehicle systems of the hydraulic circuit 1510. For example, the APU 1000 can provide hydraulic force for a hydraulic pump or to manipulate various hydraulic devices such as a main chute extender. As discussed above, various hydraulic devices can be substituted for electric devices. For example, the APU 1000 can power an electric motor to transition a main chute 46 between a deployed and stowed position, cause a rotation of the drum assembly 6, or otherwise actuate various systems of the mixer vehicle 10. According to some embodiments, the mixer vehicle 10 can omit a hydraulic system and power the various components electrically, such as via the APU 1000.

The APU 1000 can include or interface with one or more interface ports 1508. For example, the APU 1000 can include or interface with an inverter to supply a user accessible outlet (e.g., 110 VAC, 220 VAC, or the like). The interface ports 1508 can supply power for jobsite tools, cabin electronics, or the like. The APU 1000 can interface with another vehicle subsystem such as a vehicle battery different from the battery 1504 of the battery system 1502 or other charging system component. The charging system component can employ one or more voltage (e.g., 12V, 24V, 48 V, or the like). For example, the energy management controller 1520 can cause the APU 1000 to engage (e.g., startup) the ICE in response to a detection of a SoC of an energy storage device associated with the APU 1000 below a threshold, and thereafter receive electrical power from the charging system. The energy management controller 1520 can interface with a start/stop system of the ICE, (e.g., by supplying power to a charging system) which may lower a duty cycle of the ICE, and thereby further reduce emissions, relative to start stop systems lacking an interface with an APU 1000. For example, systems which interface with an APU 1000 may employ lower minimum battery voltages to reliably start the engine 74 to increase an off time while the battery discharges. In some embodiments, the energy management controller 1520 can receive an indication to start the engine 74 based on an ignition signal received from the control system (e.g., via the network 1518), and may determine a voltage of a battery 1504 of the mixer vehicle 10 prior to starting the ICE. For example, the energy management controller 1520 can employ the APU 1000 to start the engine 74 if the vehicle battery is below a threshold, and employ the vehicle battery if the vehicle battery is above the threshold.

The APU 1000 can interface with various vehicle systems such as truck or body control systems. For example, vehicle controls can receive power from the APU 1000 or another vehicle electrical system, such that the vehicle controls can operate when the ICE is disengaged and the APU 1000 is engaged, when the ICE is engaged and the APU 1000 is disengaged, or when the ICE the APU 1000 are both engaged. Such operation can employ a mechanical or solid state switch, ORing diodes, or the like to prevent back-feeding between the APU 1000 and other vehicle electrical system. The APU 1000 can include a battery jumping output for the mixer vehicle 10 or another vehicle. Such an output may interface with the vehicle electrical system or may terminate at a terminal post such that the output remains isolated from other vehicle electrical systems.

According to some embodiments, the APU 1000 may interface with one or more pneumatic pumps such as air compressors to operate various vehicle subsystems or provide an interface port 1508 for pneumatic devices such as air tools. Various hydraulic devices can be implemented as pneumatic devices. For example, vehicle pneumatic subsystems can include water tanks, pumps, chute locks, flip up hoppers, flip up axles, or the like. The energy management controller 1520 may disengage various pneumatic devices during pouring operations based on a total pneumatic capacity, or a pneumatic capacity sufficient to simultaneously conduct pouring and other operations can be provided. The energy management controller 1520 may monitor a pressure of a pneumatic system and engage an air compressor responsive to an indication that the pneumatic pressure is less than a threshold, or disengage an air compressor responsive to a determination that the pneumatic pressure is greater than a threshold. The energy management controller 1520 can selectively engage the system based on a user input or an operational characteristic, such as incident to a watering system based on an operational characteristic such as the contents of the mixer drum assembly 6, a time, or the location of the mixer vehicle 10 relative to a jobsite, plant, or another location. For example, the pneumatic systems, like other systems of the present disclosure, can be engaged such that they reach a predetermined SoC upon arrival to a plant, jobsite, or other location.

The APU 1000 can receive energy from various sources via an interface port 1508. For example, the APU 1000 can include an electrical interface 1512 to exchange power with an electrical system including a battery system 1502, a hydraulic interface 1514 to exchange power with a fluidic power system (e.g., a pneumatic or hydraulic circuit 1510), and so on. According to some embodiments, an APU 1000 can omit one or more interfaces (e.g., an APU 1000 can omit an electrical interface 1512 or hydraulic interface 1514. According to some embodiments, the interface port 1508 can include a user accessible port such as an electrical outlet, hydraulic coupling, or the like. According to some embodiments, the interface port 1508 can include a non-user accessible port such as a braised or welded line, a bus bar or the like. Although depicted as network connected devices, as referred to herein, the APU 1000 can include the battery system 1502, the hydraulic circuit 1510, or the interface ports 1508. Thus, charge received or provided by the APU 1000 can be stored via a battery 1504 of the battery system 1502, in the hydraulic circuit 1510, and so on.

The BMS controller 1506 can control a charge of the energy storage device. For example, a battery management system (BMS) can control a state of charge (SoC) of a battery 1504 and/or battery pack. Components of the BMS may be sized based on a voltage of the battery 1504 and/or battery pack. For example, a battery 1504 can include a voltage which is at least 48V and less than 96V. In some embodiments, an APU 1000 may employ battery packs of different voltages which may correspond to increased performance. For example, an APU 1000 can supply voltages in excess of 100V which may cause a drum rotation of greater than 10 RPM. According to some embodiments, the APU may limit a maximum output voltage to less than 100V to prevent undesired arcing, reduce cabling insulation or separation requirements, or the like. A battery voltage may refer to an absolute, nominal, or maximum voltage. In some embodiments, the BMS may limit a current output from the battery 1504 according to a maximum power output for the battery 1504 (e.g., to normalize a power output at various states of charge). According to some embodiments, the BMS may vary a current output according to a temperature, SoC, or other operational characteristic of the battery 1504 such that a maximum power output of the battery 1504 may vary according to the condition thereof. The BMS may prevent overcharging of the battery 1504 to reduce battery wear or avoid battery damage. The BMS may further maintain the battery 1504 in a range according to a vehicle design (e.g., based on a serviceability, insulation, or other design criteria).

Although particular values are provided herein, such values are not intended to be limiting. For example, a maximum or nominal voltage of 96V may be selected according to a particular battery chemistry, drum size, weight, or tilt, etc. For example, the battery voltage may be selected according to a drum rotational speed (e.g., 10 RPM), wiring standards, or the like. According to various implementations, greater or lesser voltages may be employed according to a desired rate of rotation for a particular drum or drum type or content thereof. Although various examples are provided with respect to a battery 1504 providing electrical energy, the systems and methods disclosed herein may be employed for other energy storage devices. For example, a fluidic charge controller can control a pressure of a compressed air or liquid (e.g., to maintain the cylinder pressure with a range).

The APU 1000 can receive power from a power-take-off, such as a power-take-off coupled to a pump, generator, the ICE, or the like. The APU 1000 can selectively engage the power-take-off according to a power demand, such as a battery charging demand, (e.g., to reduce loading when batteries 1504 are not under charge, or when the APU 1000 is disengaged or in a low power state). According to some embodiments, the disengagement of the power-take-off can disengage the charging system.

According to some embodiments, the APU 1000 can receive electrical power from regenerative braking of the mixer drum assembly 6. For example, the APU 1000 can include or interface with an electric or hydraulic motor coupled to the mixer drum assembly 6, and may harvest energy therefrom. For example, the APU 1000 can employ the electric or hydraulic motor as a generator to harvest energy from the rotation of the mixer drum assembly 6 during deceleration of the drum, such as incident to halting rotation (e.g., based on the drum assembly 6 resettling to a lowed center of gravity). In some embodiments, the APU 1000 can otherwise harvest the energy during drum operation (e.g., at a constant speed), such that energy imparted to the mixer drum assembly 6 from the ICE can be conveyed to the APU 1000.

In some embodiments, the APU 1000 can receive electrical power from an alternator coupled to the ICE. For example, the APU 1000 can electrically connect to a dedicated alternator (e.g., an auxiliary alternator), or an alternator can provide power to the APU 1000 and to other vehicle electrical systems. For example, the energy management controller 1520 can cause the BMS controller 1506 to charge the batteries 1504 according to a battery SoC, and a demand on the alternator (e.g., according to an alternator voltage, or electrical load information received from the vehicle electrical system) via the network 1518.

According to some embodiments, the energy management controller 1520 can determine a charging time, rate, or source based on a location of the vehicle, a location of a jobsite, or a condition of the contents of the mixer drum assembly 6. For example, the energy management controller 1520 can maintain the battery 1504 at a first state of charge to increase battery health (e.g., between about 30% and 70% SoC), and upon approaching a plant, jobsite, or other destination may charge the battery 1504 (e.g., above 70% SoC) to increase available energy. Such delayed charging may increase battery health relative to maintaining the battery 1504 at a maximum state of charge during transit, without a reduction of available battery capacity when then ICE is disengaged. In some embodiments, the energy management controller 1520 may determine a state of charge which may not be achieved during transit to a location. The energy management controller 1520 may determine a pre-trip charge to achieve the state of charge. For example, a depleted 50 kWh battery may be charged to 50% SoC in advance of a route, such that a remaining 50% can be charged during the route. The energy management controller 1520 can convey the pre-trip charge to a user interface 1516 (e.g., for display). For example, the user interface 1516 can be local to the vehicle or remote therefrom. Thus, vehicle idling time to charge the energy storage device can be reduced or eliminated which may reduce fuel use and vehicle emissions.

The APU 1000 can employ a pump, motor, or the like as a generator and receive electrical power therefrom. For example, the APU 1000 can receive power electrical power from a pump which can alternate between pressurizing a hydraulic or pneumatic circuit and providing electrical power therefrom, or a first pump can pressurize a hydraulic or pneumatic circuit and a second pump can generate electrical power therefrom.

The APU 1000 can receive power from an interface port 1508 such as an automotive charger or another electrical plug (e.g., j1772, NEMA 5-15, etc.). The interface port 1508 can include a level 1 charger, a level 2, charger, and so on. For example, the interface port 1508 can include an AC input, or a DC input. The input can charge or supplement the battery 1504. For example, the interface port 1508 can receive energy to reduce a depletion of an energy storage device of the APU 1000 (e.g., a battery 1504), or can charge the energy storage device. According to some embodiments, the APU 1000 can selectively engage the interface port 1508 based on a state of charge of the energy storage device. For example, the energy management controller 1520 can cause a receipt of power from the interface port 1508 responsive to a determination that a battery SoC is or may fall beneath a threshold.

The APU 1000 can include or interface with one or more modular batteries 1504. Modular batteries 1504 can be located on the concrete mixer truck 10 or connected thereto. For example, a concrete mixer truck 10 can include a battery dock to receive one or more modular batteries 1504. The modular batteries 1504 can include batteries of a same or varying voltage, capacity, etc. Modular batteries 1504 can include an identifier accessible to a controller such as the BMS controller 1506 or the energy management controller 1520. The battery identifier can include information related to a battery voltage, capacity, age, chemistry, or a unique identifier (e.g., serial number). A battery chemistry can be associated with a charging or discharging rate, profile, or the like such that a controller can charge or discharge the battery 1504 based on the identifier. The controller can track use based on the unique identifier which may be conveyed to a controller of the mixer vehicle 10 or a controller remote from the mixer vehicle 10 which may determine replacement, storage, prognostics, analytics, or the like.

The controller remote from the mixer vehicle 10 may receive or process battery data for a fleet of one or more vehicles. The batteries may be shared between various trucks, units, jobsites, and so forth. For example, a vehicle can include a port to connect to a modular battery 1504 located at a plant or jobsite, or can include interfaces for a jobsite coupled to the battery 1504 of the vehicle, such as the pneumatic or electrical interface ports disclosed herein 1508. The modular batteries 1504 can include batteries 1504 of various capacities. For example, an energy management controller 1520 can select a battery 1504 for a vehicle or jobsite according to a predicted use thereof. A battery dock can extend (e.g., slide out) from a vehicle to aid in removal or replacement of the battery 1504. For example, battery rails can extend a battery dock from a vehicle for battery interchange. In some embodiments, vehicles can include interface ports 1508 to exchange energy between trucks, such that a subset of trucks can include a battery, and upon arrival at a site, the trucks can connect to each other or to a jobsite battery 1504 to practice the systems and methods disclosed herein. According to some embodiments, a detachable trailer can include the APU 1000 comprising the battery 1504 or battery dock, such that various vehicles or jobsites can employ the APU trailer. The APU trailer can interface with the trucks via an electrical receptacle, hydraulic connection (e.g., a power-take-off), etc.

In some embodiments, the battery 1504 or dock is disposed laterally between the frame rails 40. Such a mounting may center a mass of the battery 1504, and provide mechanical protection to the battery 1504. For example, the frame rails 40 or the front cross-member 700 can provide mechanical protection to the battery 1504; under-cladding may provide further mechanical protection, such as with regard to road debris, or from terrain features extending from the ground. The battery 1504 can be configured to thermally interface with any of the frame rails 40, various cross-members, under-cladding, or cold plates to thermally sink the battery 1504. In some embodiments, the battery 1504 may be mounted vertically above the frame rails 40, such as immediately below the front pedestal 16, the rear pedestal 26, or therebetween (e.g., under the mixing drum 14, such as a front third portion thereof). Such placement may aid in battery accessibility and weight distribution. In some embodiments, the battery 1504 may be mounted along a side of the vehicle laterally extending beyond the frame rails 40. For example, a battery 1504 can be mounted along at least one side of the vehicle (e.g., cross mounted) such that each battery 1504 is accessible to a user which may aid in battery exchange, or reduce a length of a charging cable for the battery 1504 to reduce resistive losses.

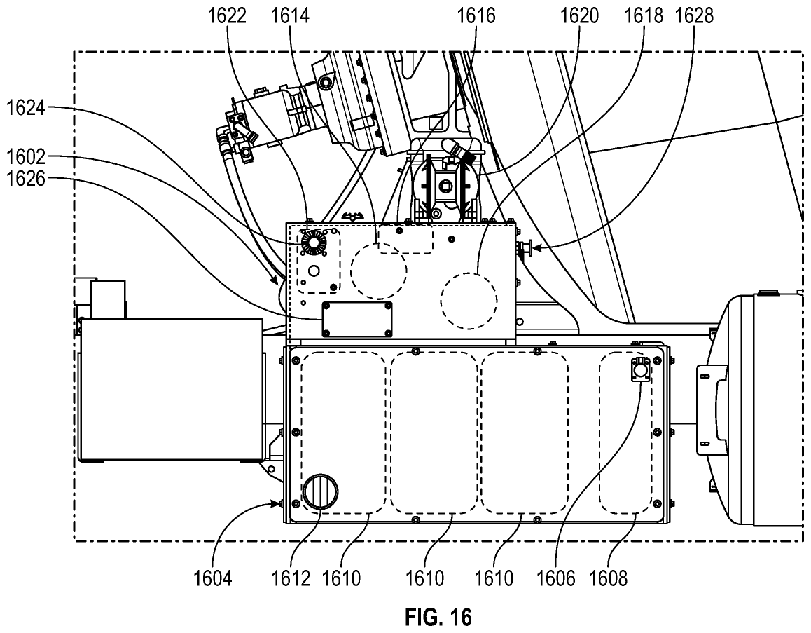

According to some embodiments, various equipment (e.g., pumps, motors, or the like) can be collocated with the batteries 1504 or other APU components as is further described with regard to FIG. 16. In some embodiments, various mounting locations can be configured to receive a battery 1504 or other equipment (e.g., can receive mounting studs, receptacles or other interfaces). For example, various motors, pumps, inverters, batteries 1504, and other devices can be employed according to an application, such that various mounting locations may be employed. For example, various modular components such as a battery 1504 can be mounted to a location according to a size available, or a device type (e.g., a hydraulic pump can be mounted at a location proximal to a hydraulic circuit 1510, which is also configured to receive electrical supply suitable for an electric motor). Thus, interchanging within or between hydraulic, electric, and other devices may be simplified according to an application. In some embodiments, a unitary APU 1000 comprising a battery 1504, charging pack, energy management controller 1520, pump, valve pack, and so on can be mounted to the mixer truck 10 as a line replaceable unit.

Various devices of the mixer truck 10 may be in network communication via respective network interfaces. The network interfaces can communicate over one or more wired or wireless transceivers employing various protocols such as a controller area network 1518 (CAN), local interconnect network 1518 (LIN), Ethernet (e.g., two-wire automotive Ethernet), Bluetooth, Wi-Fi, a cellular network 1518, or the like to form a network 1518. The network 1518 can include various physical or protocol interfaces between various devices, such that some devices may serve as gateways for other devices, or multiple network interfaces can be available for certain devices. For example, a device can include internal and external facing networks such that various communications may be addressed to a device generally, and upon receipt of a network message, the device can convey relevant information to a component thereof. Some depicted components can include various addressable network interfaces. For example, the ICE or hydraulic circuit 1510 can include various individually addressable controllers, pumps, sensors, and the like.

The network 1518 can include or interface with various sensors or controls of the concrete mixer truck 10. For example, the network 1518 can convey mixer control information such as a commanded speed of the mixer drum assembly 6, an injection of water to a mix within the drum, or the like. For example, a body control system can integrate various systems such that the energy management controller 1520 can query the body control system for various measured or detected values for the vehicle, or may query various sensors of the body control system. In some embodiments, the mixer control information is integrated with automotive control information such as RPM, fuel use, alternator amperage, ignition signals, run signals, chassis parameters, or the like. In some embodiments, the energy management controller 1520 can receive various inputs from sensors, such as by various digital input outputs (DIO), analog run signals, or the like which may correspond to pushbutton controls, ignition positions, etc. The energy management controller 1520 can process the information locally or convey the information over the network 1518 (e.g., for display by the user interface 1516).

A controller such as the energy management controller 1520 can convey a parameter of the concrete mixer truck 10 for presentation by the user interface 1516. The parameters can include temperature information for a hydraulic system, a charging circuit, or a battery module (e.g., one or more cells thereof). The parameters may further include a SoC of an energy storage device. For example, a battery voltage, percent SoC, time to depletion, cycles to depletion, or other indication of the SoC of the energy storage device may be presented. The parameters can include a value of a temperature, or an operational characteristic 1060, such as an over-temperature condition, under-temperature condition, or the like. The parameter can include a real-time, rolling average, or historical indication of power flows between the various components of the mixer vehicle 10. For example, power flow between one or more interface ports 1508 and the vehicle, or between the batteries 1504 and the various power sources can be depicted. Such a depiction can include energy flowing to the mixer drum assembly 6 from the APU 1000, or to the batteries 1504 from an interface port 1508. The energy management controller 1520 can cause a historic use of the APU 1000 (e.g., hours, kWh, joules, etc.) to be displayed on the user interface 1516 by conveying the information to the user interface 1516. The user interface 1516 may depict APU status, such as an SoC or health (e.g., maximum charge relative to original maximum charge). The user interface 1516 may depict a total fuel savings, monetary savings, or emissions reduction (e.g., CO₂ or CO₂ equivalent).

The user interface 1516 can include one or more displays. The displays may be attached to, removable from, or remote from the vehicle. For example, the user interface 1516 can include an integrated display for information specific to the mixing unit and general vehicle information, separate displays for each, or a first display and an optionally included second display including further information (e.g., non-digital information which is received through various DIO/analog inputs). A display of a user interface 1516 can be removable from a vehicle, and connected to the vehicle by a wireless network 1518 such that the display can provide information from vehicle networks, including wired networks (e.g., CAN) remote from and proximal to the vehicle, such as at a rear of a vehicle during a pouring operation. The display may receive user commands such as an indication to increase watering, manipulate a chute, and so on, and convey the commands to a controller of the mixer vehicle 10 such as the energy management controller 1520 or the controller of FIG. 10.

Referring now to FIG. 16, a unitary APU 1000 including a power unit 1602 and a storage unit 1604 is depicted, according to some embodiments. The power unit 1602 can exchange energy between the storage unit 1604 and other portions of the mixer vehicle 10 (e.g., various devices of an electrical or fluidic circuit such as the drum driver 114, various interface ports 1508, or the like). The storage unit 1604 can include an energy storage device and a corresponding interface port 1508 according to the various embodiments of the present disclosure. For example, the storage unit 1604 can include a storage unit charging port 1606 electrically connected to a charging circuit 1608 for a battery 1504 including one or more battery modules 1610 which are collocated in the storage unit 1604 or otherwise disposed according to the various embodiments of the present disclosure (e.g., a jobsite battery 1504, trailered battery 1504, or another battery 1504 of the mixer vehicle 10 coupled alongside or between the frame rails 40 thereof). In some embodiments, the storage unit charging port 1606 can be disposed remote from the storage unit 1604. For example, the charging port 1606 can be disposed proximal to an on-vehicle, or off-board charging source. In some embodiments, the charging port 1606 can electrically connect to the power unit 1602 in addition to or instead of the storage unit 1604. For example, the charging port 1606 can be conveniently located in a location proximal to a charging source which may be integral to or remote from the APU 1000.

The charging port 1606 or other ports of the power unit 1602 or storage unit 1604 (e.g., a power disconnection contactor 1628) can connect to the APU 1000 via electrical, hydraulic, or pneumatic lines. The various lines can include protection from foreign objects or debris, chemical contaminants, and the like. For example, mechanical sheathing can surround various electric, hydraulic, or pneumatic lines which may offer resistance to mechanical impact or abrasion. Chemical resistant insulation can surround lines to offer chemical resistance, and so on. Various lines can be mounted along a surface of the frame rail 40 or other chassis 12 member which may protect the lines from debris such as road-borne debris. A plug or receptacle of the APU 1000 can interface with a cover, such as a hingedly connected cover, a friction fit plug, or the like, to protect terminals from environmental contaminants or damage.

The various battery modules 1610 of the storage unit 1604 can be arranged in a series or parallel configuration, such that a physical dimension of the storage unit 1604 can vary according to a selected voltage or capacity thereof. The storage unit 1604 can include thermal management devices for the various battery modules 1610, such as a cold plate (e.g., a sidewall of the storage unit 1604 which interfaces with an ambient environment around the mixer vehicle 10). In some embodiments, the storage unit 1604 can include or interface with a thermal device. In one embodiment, the thermal device is an active thermal device. An active thermal device can include a cooling fan coupled to the storage unit 1604 to exchange heat between the storage unit 1604 and an ambient environment through vents 1612 disposed in the body of the storage unit 1604. An active thermal device can include liquid thermal management which may interface with a hydraulic system such as via a heat exchanger of the hydraulic circuit 1510 to heat or cool a battery 1504. An active thermal device can include a warming plate (e.g., a plate containing a heating element to modulate battery temperature). The BMS controller 1506 can actuate an active thermal device in response to a detected condition such as a battery temperature, ambient temperature, power demand, or another operation status of the mixer vehicle 10. The active thermal device can be configured to actuate between heating and cooling modes depending on the time of year or operating conditions. In some embodiments, the thermal device can include warming blankets (e.g., a material containing a resistive element, resistive heater, or the like) to increase a battery temperature in cold operating conditions. The warming blankets may also insulate the batteries 1504 to prevent excessive heat transfer to or from the surroundings.

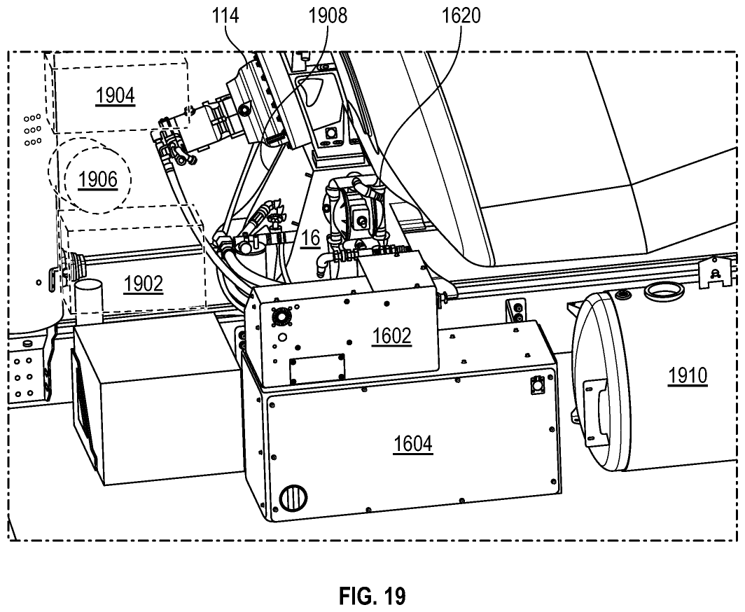

The power unit 1602 is connected to the storage unit 1604 by an electrical, fluid, or mechanical connection. For example, the power unit 1602 can be coupled to the storage unit 1604 such that any interconnections can be integral to the power unit 1602 or the storage unit 1604. A plug or receptacle of the power unit 1602 can interface with a corresponding plug or receptacle of the storage unit 1604, which may obviate or reduce cabling between the power unit 1602 and the storage unit 1604. In some embodiments, the power unit 1602 can be disposed separately from the storage unit 1604. For example, the power unit 1602 can be located proximal to the drum driver 114, as is further discussed with regard to FIG. 19. The power unit 1602 can include active or passive thermal management, such as via a thermally conductive body of the power unit 1602, vents 1622 of the power unit 1602, or the like.

According to some embodiments, the power unit 1602 can include a hydraulic pump 1614, one or more valves 1616, an electric motor 1618, or an inverter 1624. The hydraulic pump 1614 can connect to an electric motor 1618 of the power unit 1602, and can convey fluidic power to cause a rotation of a drum driver 114 to rotate the mixing drum 14. The valves 1616 can include the check valves discussed with regard to FIG. 15. For example, the valves 1616 can intermediate the hydraulic pump 1614 of the power unit 1602 and another hydraulic pump 1620, which may interface with the mixer vehicle 10 engine 74. Such valves 1616 can prevent or control back-feeding between various devices of a hydraulic circuit 1510 of the vehicle. The electric motor 1618 can couple to the hydraulic pump 1614 to exchange energy from electrical and hydraulic circuits. The inverter 1624 can exchange energy between the storage unit 1604 (e.g., a DC battery voltage) and an electric motor 1618 of the power unit 1602 (e.g., an AC motor). In some embodiments, the power set can include a rectifier to cause energy to be conveyed from the electric motor 1618, operating as a generator, to the battery modules 1610 of the storage unit 1604. For example, the inverter 1624 can include or interface with a rectifier. According to some embodiments, various devices can be exchanged between the power unit 1602, the storage unit 1604, or other locations on the electric vehicle. For example, the storage unit 1604 can include one or more regulated voltage output such that the inverter 1624 of the power unit 1602 can be omitted, or valves 1616 can be disposed throughout the mixer vehicle 10. The power unit 1602 can include various components according to a various embodiments of the APU 1000 disclosed herein. For example, some APU 1000 may omit a hydraulic or electrical circuit and may thus contain additional, fewer, or different components. In some embodiments, an APU 1000 can couple an electric drum drive or other electrical components, and may omit a hydraulic pump 1614, one or more valves 1616, or the like.

A power disconnection contactor 1628 (e.g., emergency stop) can be disposed along an exterior surface of the power unit 1602. In some embodiments, the power disconnection contactor 1628 can be remote from power unit 1602 which may improve accessibility of the contactor 1628 according to various installation locations. For example, the power disconnection contactor 1628 can be collocated with a remote storage unit charging port 1606 that is disposed on the power unit 1602, or disposed away therefrom. As described above, the charging port 1606 can be conveniently located closer to a charging source and configured in such a way as to eliminate contamination from the elements or other debris. The power disconnection contactor 1628 can be or include a normally open or normally closed switch. The actuation of the power disconnection contactor 1628 can cause one or more components of the power unit 1602 to de-energize. For example, the power disconnection contactor 1628 can de-energized an electrical or hydraulic circuit 1510. The power unit 1602 can include a removable panel 1626 to access controls, valves, or serviceable components thereof. For example, the removable panel 1626 can be removable without dismounting the power unit 1602. One or more controls can be accessed by the removal of the removable panel 1626. The controls can include components of or interfaces for the control system 1010. For example, upon an actuation of the power disconnection contactor 1628, a second control (e.g., reset) can be accessed by a removal of the removable panel 1626.

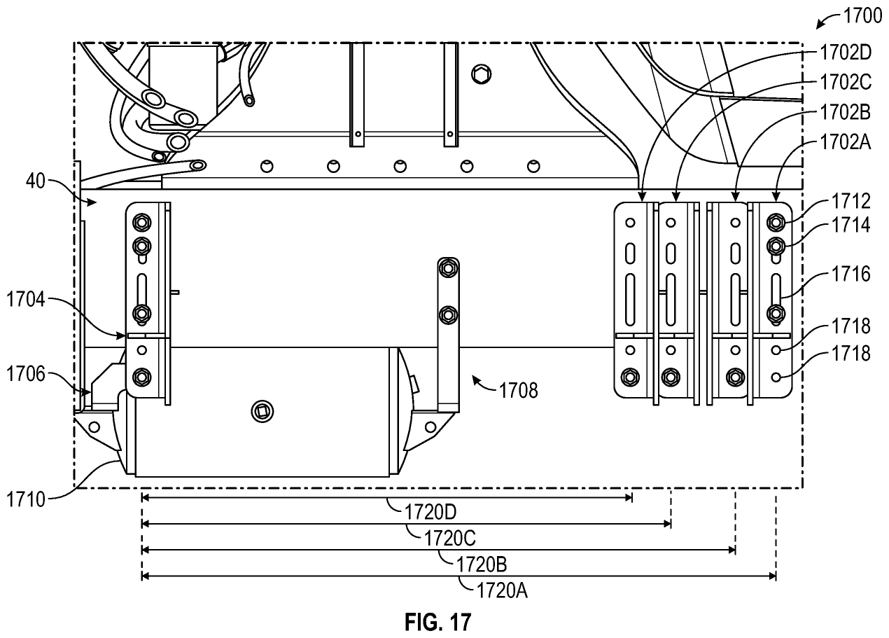

Referring now to FIG. 17, a kit 1700 for mounting an APU 1000, such as the modular APU 1000 of FIG. 16, is depicted. The kit 1700 includes a first mounting bracket 1702 to couple a power unit 1602, a storage unit 1604, or another APU portion to the mixer vehicle 10. For example, the first mounting bracket 1702 can include mounting holes to interface with a frame rail 40 of the mixer vehicle 10. A second mounting bracket 1704 can include mounting holes to interface with the mixer vehicle 10. For example, the second mounting bracket 1704 can be configured to attach to a same frame rail 40 as the first mounting bracket 1702 such that the mounting brackets can extend longitudinally along a surface of the frame rail 40 (e.g., an interior or exterior surface thereof), between two frame rails 40, or along a cross-member 402. According to various embodiments, the kit 1700 can include additional or fewer mounting brackets. For example, according to some embodiments, a mounting bracket for the power unit 1602 or storage unit 1604 can be disposed along the frame rail 40 intermediate to the first mounting bracket 1702 and the second mounting bracket 1704.

Either of the first mounting bracket 1702 or the second mounting bracket 1704 can include mounting holes to connect the respective bracket to the mixer vehicle 10 (e.g., to a frame rail 40 thereof). Such mounting holes can be slotted or un-slotted holes. For example, various mounting brackets can include one or more un-slotted holes, or slotted holed having index marks to align the bracket to a pre-defined position. Further mounting holes can be configured with slotted holes to interface with various predefined mounting points (e.g., threaded or unthreaded holes, detents, studs, or the like) or to conform to a tolerance for a mounting point location. In some embodiments, the first mounting bracket 1702 and the second mounting bracket 1704 can include mounting holes of a same pattern. For example, the first mounting bracket 1702 and the second mounting bracket 1704 can be of a same footprint or overall design, be mirrored, or otherwise configured to interface with a vertically defined connection, such as along a frame rail 40 of the mixer vehicle 10. As depicted, each of the first mounting bracket 1702 and the second mounting bracket 1704 include an uppermost non-slotted mounting hole 1712, and a first 1714 and second slotted hole 1716. The first 1714 and second slotted hole 1716 may overlap with at least one frame rail mounting point (e.g., may include mounting hole locations for the third mounting bracket 1708).

In some embodiments, a mounting bracket can include at least one inferior mounting hole 1718 disposed vertically below the frame rails 40. Such inferior mounting holes 1718 can be employed to mechanically couple to a device or an extension bracket 1706 without passing through the frame rail 40. According to some embodiments, the mounting brackets can be reversible along a plane perpendicular to the frame rail 40 such that mounting holes (e.g., slotted mounting holes) can interface with a mounting point of the frame rail 40 or a component of the APU 1000 (e.g., the power unit 1602 or the storage unit 1604).

At least the first mounting bracket 1702 and the second mounting bracket 1704 can be mechanically independent such that a distance therebetween can be varied. The longitudinal position of the first mounting bracket 1702 relative to the second mounting bracket 1704 can vary according to a selected dimension of a the position of a storage unit 1604. For example, a first mounting bracket 1702 can be disposed at a first location 1702A extending a first distance 1720A from the second mounting bracket 1704; a second location 1702B extending a second distance 1720B from the second mounting bracket 1704; a third location 1702C extending a third distance 1720C from the second mounting bracket 1704; or a fourth location 1702D extending a fourth distance 1720D from the second mounting bracket 1704. According to some embodiments, a lateral dimension of a bracket can be equal to or less than the difference in lateral dimension between various modular storage units 1604 (or other APU portions) such that more than one first mounting bracket 1702 or second mounting bracket 1704 can be installed on a frame rail 40. For example, a mounting bracket having a dimension of three inches can couple to various modular storage units 1604 having a difference of at least three inches (e.g., first mounting brackets can be mounted in each of the first location 1702A, second location 1702B, third location 1702C, and fourth location 1702D). The kit 1700 can include multiple first mounting brackets 1702 or second mounting brackets 1704. Such a configuration may ease replacement of modular storage units 1604 or other line replaceable units of varying dimension.

Either of the first mounting bracket 1702 or the second mounting bracket 1704 can couple to further elements of the mixer vehicle 10 such as devices of electrical or fluidic circuits. For example, the second mounting bracket 1704 is depicted as coupled to a hydraulic reservoir 1710 by an extension bracket 1706. Further brackets can couple devices (e.g., the depicted hydraulic reservoir 1710) to the vehicle, such as via a third mounting bracket 1708 intermediate to the first mounting bracket 1702 and the second mounting bracket 1704. The extension bracket 1706 can maintain a disposition of the hydraulic reservoir 1710 which is vertically inferior to the hydraulic pump of the power unit 1602. Such a disposition can cause hydraulic fluid to drain from the hydraulic pump 1614 of the power unit 1602, such as during non-operation of the APU 1000. For example, the extension bracket 1706 or the third mounting bracket 1708 can include a lateral extension perpendicular to the frame rails 40 to cause the hydraulic reservoir 1710 to extend below an underside of a frame rail 40. The depicted disposition of the hydraulic reservoir 1710 is not intended to be limiting. Indeed, the hydraulic reservoir can be located at various positions of the mixer vehicle 10, such as proximal to the drum driver 114, or within the power unit 1602.

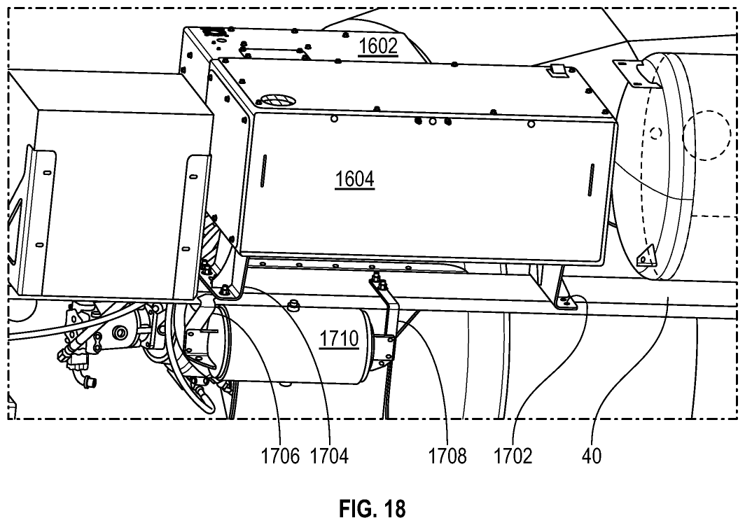

Referring now to FIG. 18, a bottom view of the APU 1000 of FIG. 16 coupled to the mounting kit 1700 of FIG. 17 is depicted, according to an exemplary embodiment. The first 1702, second 1704, and third 1708 mounting brackets mechanically couple the storage unit 1604 of the APU 1000 to the depicted frame rail 40. The power unit 1602 of the APU 1000 is mounted to an upper surface of the storage unit 1604. In some embodiments, the APU 1000 can be differently disposed or differently configured. For example, the power unit 1602 can be coupled to a bottom surface of the storage unit 1604, to the frame rail 40, or remote from the storage unit 1604 (e.g., coupled to the storage unit 1604 by a hydraulic or electric line of a respective circuit). As depicted, the hydraulic reservoir 1710 is coupled to the frame rail 40, and extends below a bottom surface thereof.

Referring now to FIG. 19, an isometric view of the APU 1000 is provided, according to an exemplary embodiment. The power unit 1602 and storage unit 1604 of the APU 1000 are mounted along the exterior portion of the frame rails 40. The power unit 1602 can be configured for mounting at various positions along the mixer vehicle 10. Such a modular power unit 1602 can be employed with mixer vehicles 10 having various configurations including aftermarket equipped devices. For example, the power unit 1602 can be located between a cab 18 and a mixing drum 14 of the mixer vehicle 10. The power unit 1602 can be contained in a rack or other equipment assemblage, such that the power unit 1602 can mount to the mixer vehicle 10 at a first position 1902 or second position 1904 along a rear face of the cab 18. A rack or other equipment assemblage may include the hydraulic reservoir 1710, at least a portion of which may extend vertically below the power unit 1602 (e.g., at a third position 1906, extending below the second position 1904). Other mounting locations may be employed according to a vehicle clearance. For example, the power unit 1602 can be coupled to the front pedestal 16 or between the mixing drum 14 and an upper or lower surface of the frame rails 40, at a fourth position 1908. According to some embodiments, all or some modular power units 1602 or can fit at various locations on the vehicle. The various units can employ different maximum or peak power, or be configured for various operating conditions (e.g., temperatures, run times, an interfacing control system 1010, or the like). For example, a modular power unit 1602 can be selected according to a volume available at a selected mounting point and a distance to one or more devices of a hydraulic circuit 1510 such as a hydraulic drum driver 114 or another pump 1620 of the hydraulic circuit. Moreover, one or more storage units 1604 can be selected according to a space available at one or more mounting points. For example, various storage units 1604 can be mounted to an exterior or interior surface of the frame rails 40, at the first 1902, second 1904, or third 1906 mounting location, along the front pedestal 16, under the drum, or along other portions of the mixer vehicle, and electrically connected to the power unit 1602.

A pneumatic reservoir 1910 is depicted. The pneumatic reservoir 1910 can interface with the APU 1000. For example, the APU 1000 can provide fluidic power to the pneumatic reservoir 1910 or derive fluidic power therefrom. For example, the APU 1000 can exchange electrical power or hydraulic power with pneumatic power, or may employ pneumatic power (e.g., to actuate a pilot valve interfacing or included in the power unit 1602).

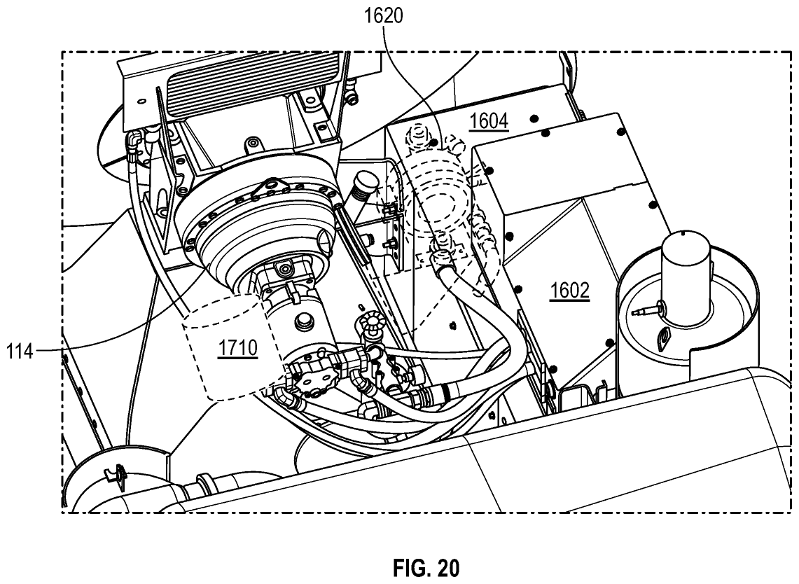

Referring now to FIG. 20, a top isometric view of the APU 1000 is provided, according to an exemplary embodiment. As depicted, the hydraulic reservoir 1710 is at least fluidly coupled to the drum driver 114. The hydraulic reservoir 1710 can also be mechanically coupled to the drum driver 114, or a distance between the hydraulic reservoir 1710 and the drum driver 114 can otherwise be reduced, relative to other embodiments such as those described herein. The power unit 1602 can be elevated above the reservoir, such as according to a location described with regard to FIG. 19. As depicted, the other hydraulic pump 1620 of the hydraulic circuit 1510 may be omitted or disconnected from the hydraulic circuit 1510.

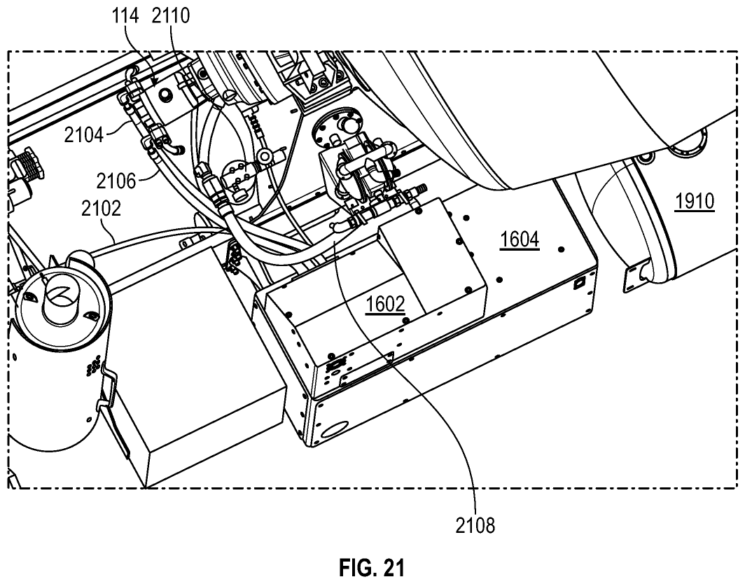

Referring now to FIG. 21, another top isometric view of the APU 1000 is provided, according to an exemplary embodiment. As depicted, the power unit 1602 can include various interface ports connecting to various electrical, hydraulic, or pneumatic ports. For example, a first connection 2102 can connect to a hydraulic reservoir; a second connection 2104 or a third connection 2106 can connect to the drum driver 114. A fourth connection 2108 can connect to another device of the hydraulic circuit, such as a filter element 2110. Such example connections are not intended to be limiting. According to the various embodiments disclosed herein, various connections to the hydraulic circuit, a pneumatic circuit (e.g., a pneumatic reservoir), or an electrical circuit can be employed, and energy can be exchanged by each connection.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the mixer vehicle 10 and the systems and components thereof as shown in the various exemplary embodiments is illustrative only. Additionally, any element disclosed in one embodiment may be incorporated or utilized with any other embodiment disclosed herein.

What is claimed is:

1. A concrete mixer vehicle comprising:
a mixer drum assembly;
an energy storage device;
an internal combustion engine (ICE) configured to supply power to the mixer drum assembly;
an auxiliary power unit (APU) configured to supply power from the energy storage device to the mixer drum assembly; and
an energy management controller configured to engage the APU and disengage the ICE based on a state of charge of the energy storage device.

2. The concrete mixer vehicle of claim 1, wherein the energy management controller is configured to engage the ICE based on a rotational speed of the mixer drum assembly.

3. The concrete mixer vehicle of claim 2, wherein the energy management controller is configured to engage the ICE for the rotational speed which is in excess of 10 rotations per minute (RPM).

4. The concrete mixer vehicle of claim 2, wherein:
the energy storage device is a battery; and
the APU is configured to receive energy from the ICE and convey said energy to charge the battery.

5. The concrete mixer vehicle of claim 4, wherein the energy received from the APU comprises hydraulic power received via a power-take-off unit.

6. The concrete mixer vehicle of claim 1, wherein the energy management controller is configured to disengage the ICE in response to rotational speed of the mixer drum assembly being less than approximately 10 RPM.

7. The concrete mixer vehicle of claim 1, wherein the energy management controller is configured to provide energy to engage the ICE.

8. The concrete mixer vehicle of claim 1, wherein the APU is configured to supply hydraulic power to the mixer drum assembly.

9. The concrete mixer vehicle of claim 1, wherein the APU and the ICE are configured to simultaneously exchange energy with the mixer drum assembly.

10. The concrete mixer vehicle of claim 1, wherein the APU is disposed within a trailer of the concrete mixer vehicle.

11. The concrete mixer vehicle of claim 1, wherein the energy management controller is configured to control a throttle of the ICE based on an efficiency associated therewith.

12. A system comprising:
a mixer drum assembly;
an energy storage device;
an internal combustion engine (ICE) configured to supply power to the mixer drum assembly;
an auxiliary power unit (APU) configured to supply power from the energy storage device to the mixer drum assembly; and
an energy management controller configured to engage the APU and disengage the ICE based on a state of charge of the energy storage device.

13. The system of claim 12, wherein:
the energy storage device is a battery; and
the energy management controller is configured to determine an identifier for the battery, and thereafter charge the battery based on a charge profile that is associated with the identifier.

14. The system of claim 13, wherein the energy management controller is configured to convey the identity of the battery and a use of the battery to another controller, and thereafter receive an updated charge profile based on the use of the battery.

15. The system of claim 12, comprising a user interface, the user interface configured to present an indication of battery health.

16. The system of claim 12, comprising a user interface, the user interface configured to provide an indication of a battery state of charge.

17. The system of claim 12, wherein the energy management controller is configured to determine a charging profile based on a location of a concrete mixer vehicle, a destination of the concrete mixer vehicle, and the state of charge of the energy storage device.

18. The system of claim 13, wherein the APU is configured to selectively receive energy from and contribute energy to a hydraulic circuit.

19. The system of claim 13, wherein the APU omits a hydraulic interface port.

20. An energy management controller for a mixer vehicle configured to execute computer-readable instructions to:
receive a state of charge of an energy storage device;
compare the state of charge of the energy storage device to a threshold; and
based on the comparison, selectively engage one of an internal combustion engine (ICE) or an auxiliary power unit (APU) to supply power to a mixer drum assembly.
